(19) United States
(12) Patent Application Publication
(10) Pub. No.: US 2026/0163753 A1
(43) Pub. Date: Jun. 11, 2026

(54) AUGMENTING SPEECH TRANSCRIPTS OF VIRTUAL REALITY RECORDINGS

(71) Applicant: AUTODESK, INC., San Francisco, CA (US)

(72) Inventors: Frederik BRUDY, Toronto (CA); George William FITZMAURICE, Toronto (CA); Riccardo BOVO, London (GB); Fraser ANDERSON, Newmarket (CA)

(21) Appl. No.: 19/181,221

(22) Filed: Apr. 16, 2025

Related U.S. Application Data
(60) Provisional application No. 63/658,826, filed on Jun. 11, 2024.

(51) Int. Cl. H04L 12/18; G06F 3/01

(52) U.S. Cl. CPC H04L 12/1831; G06F 3/013

(57) ABSTRACT

One embodiment sets forth a technique for generating an augmented transcript of a single-user virtual reality (VR) session. According to some embodiments, the technique includes the steps of identifying a first referring expression in a text transcript of the VR session performed by a user in a VR environment; analyzing one or more non-verbal behaviors of the user during the VR session to determine a first VR object in the VR environment associated with the first referring expression; and specifying a first name of the first VR object in the text transcript to generate the augmented transcript. Another embodiment sets forth a technique for generating an augmented transcript of a two-user virtual reality (VR) session.

### CROSS-REFERENCE TO RELATED APPLICATIONS

This application claims priority benefit of the U.S. Provisional Patent Application titled, “AUGMENTING SPEECH TRANSCRIPTS OF VIRTUAL REALITY RECORDINGS WITH CONTEXT FOR MULTIMODAL CONFERENCE RESOLUTION,” filed on Jun. 11, 2024, and having Ser. No. 63/658,826. The subject matter of this related application is hereby incorporated herein by reference.

### BACKGROUND

### Field of the Various Embodiments

The various embodiments relate generally to computer-aided speech transcripts, and, more specifically, to augmenting text transcripts of virtual reality sessions.

### Description of the Related Art

Performing reviews, commentary, and/or conversations/discussions for three-dimensional (3D) design projects in a virtual reality (VR) environment during a VR session is becoming a popular collaboration approach. For example, the 3D design project can include an architectural design of a room, building, or building site, a mechanical design of a vehicle or other assembly, an electrical design of a computer system, audio system, or other electrical system, or any other type of design project. The 3D design project can be rendered and presented in a VR environment while one or more users navigate the VR environment and provide verbal speech/commentary regarding the 3D design project during a VR session. For example, the one or more users can provide verbal commentary on issues, critiques, considerations, and personal preferences regarding various objects of the 3D design project during the VR session.

During a single-user VR session, a single user can view the 3D design project in the VR environment via a VR headset, interact with VR objects in the VR environment via a VR controller, and provide a verbal commentary on various VR objects of the 3D design project. During a two-user VR session, a first user and a second user can each view the 3D design project in the VR environment via separate VR headsets, interact with VR objects in the VR environment via separate VR controllers, and have a verbal conversation/discussion on various VR objects of the 3D design project. An audio recording of the verbal commentary or conversation during the VR session can be captured via a microphone on the VR headset of the one or two users.

In some cases, a transcript application can process the audio recording of the VR session to provide a text transcript of the VR session. The text transcript of the VR session typically includes a number of referring expressions (REs). Each referring expression in the text transcript is a word, such as “this,” “that,” or “it,” which references/indicates a specific object, but the specific identity of the referenced object often is ambiguous. An RE transcript application can be used to process the text transcript to attempt to “resolve” the referring expressions contained in the text transcript. Resolving a particular referring expression contained in a text transcript means that the referenced object corresponding to the particular referring expression is identified and then specified in the text transcript, which can also be referred to as coreference resolution. Conventional RE transcript applications can typically resolve explicit referring expressions accurately. An explicit referring expression contains the referenced object within the same sentence as the referring expression. For example, “This table looks too large” contains the referenced object “table” in the same sentence as the explicit referring expression “this.” A conventional RE transcript application can accurately resolve such an explicit referring expression, for example, by implementing a large language model.

One drawback of conventional RE transcript applications is that conventional RE transcript applications typically cannot accurately resolve implicit referring expressions that do not contain the referenced object within the same sentence as the referring expression. For example, “This looks too large” does not contain any referenced object in the same sentence as the implicit referring expression “this.” As conventional RE transcript applications typically rely on only verbal behaviors (speech commentary or conversation) of the users—and do not leverage non-verbal behaviors of the users in the VR session—conventional RE transcript applications typically cannot accurately resolve such implicit referring expressions. Another drawback of the above approach is that, because the implicit referring expressions in the text transcript are not accurately resolved by conventional RE transcript applications, any additional post-processing of the text transcript will also have inaccuracies/errors. For example, a post-processing application that provides a summary of the text transcript will generate a summary having similar errors as the text transcript having inaccurate resolutions of the implicit referring expressions.

As the foregoing illustrates, what is needed in the art are more effective techniques for resolving implicit referring expressions in text transcripts of VR sessions.

### SUMMARY

One embodiment sets forth a computer-implemented method for generating an augmented transcript of a single-user virtual reality (VR) session. According to some embodiments, the method includes the steps of identifying a first referring expression in a text transcript of the VR session performed by a user in a VR environment; analyzing one or more non-verbal behaviors of the user during the VR session to determine a first VR object in the VR environment associated with the first referring expression; and specifying a first name of the first VR object in the text transcript to generate the augmented transcript.

At least one technical advantage of the disclosed techniques relative to the prior art is that the disclosed techniques consider non-verbal behaviors of a single user during a single-user VR session to resolve referring expressions in a text transcript of the VR session. The non-verbal behaviors can include a pointing behavior and/or gaze behavior of the single user in relation to various VR objects in the VR environment during the VR session. In this manner, the non-verbal behaviors of the single user during the VR session can be leveraged to more accurately resolve referring expressions in a text transcript relative to prior approaches that did not consider non-verbal behaviors of the user and considered only verbal behaviors of the user when resolving referring expressions in the text transcript. These technical advantages provide one or more technological advancements over prior art approaches.

Another embodiment sets forth a computer-implemented method for generating an augmented transcript of a two-user virtual reality (VR) session. According to some embodiments, the method includes the steps of identifying a first referring expression in a text transcript of the VR session performed by a first user and a second user in a VR environment; analyzing at least one concurrent or recurrent non-verbal behavior of the first user and the second user during the VR session to determine a first VR object in the VR environment associated with the first referring expression; and specifying a first name of the first VR object in the text transcript to generate the augmented transcript.

At least one technical advantage of the disclosed techniques relative to the prior art is that the disclosed techniques consider concurrent or recurrent non-verbal behaviors of a first user and a second user during a two-user VR session to resolve referring expressions in a text transcript of the VR session. The non-verbal behaviors can include a concurrent or recurrent pointing behavior of the first user and the second user and/or a concurrent or recurrent gaze behavior of the first user and the second user in relation to various VR objects in the VR environment during the VR session. In this manner, the non-verbal behaviors of the first user and the second user during the VR session can be leveraged to more accurately resolve referring expressions in a text transcript relative to prior approaches that did not consider non-verbal behaviors of the users and considered only verbal behaviors of the users when resolving referring expressions in the text transcript. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a VR transcript system configured to implement one or more aspects of the various embodiments;

FIG. 2 is a more detailed illustration of the VR system of FIG. 1, according to various embodiments;

FIG. 3 is a more detailed illustration of the speech transcript (ST) system of FIG. 1, according to various embodiments;

FIG. 4 is a more detailed illustration of the augmented transcript (AT) system of FIG. 1, according to various embodiments;

FIG. 5 is a conceptual illustration of a set of single-user transcripts generated for a single-user VR session, according to various embodiments;

FIG. 6 is a conceptual illustration of a single-user VR session in a VR environment, according to various embodiments;

FIG. 7 is a conceptual illustration of a pair of relevant fixation sequences that satisfy the concurrent pointing and gaze metric, according to various embodiments;

FIG. 8 is a conceptual illustration of relevant fixation sequences that satisfy the pointing metric, according to various embodiments;

FIG. 9 is a conceptual illustration of relevant fixation sequences that satisfy the gaze metric, according to various embodiments;

FIG. 10 sets forth a flow diagram of method steps for generating an augmented transcript for a single-user VR session, according to various embodiments;

FIG. 11 is a conceptual illustration of a set of two-user transcripts generated for a two-user VR session, according to various embodiments;

FIG. 12 is a conceptual illustration of a two-user VR session in a VR environment, according to various embodiments;

FIG. 13 is a conceptual illustration of a pair of relevant fixation sequences that satisfy the concurrent pointing metric, according to various embodiments;

FIG. 14 is a conceptual illustration of a pair of relevant fixation sequences that satisfy the recurrent pointing metric, according to various embodiments;

FIG. 15 is a conceptual illustration of relevant fixation sequences that satisfy the single-user pointing metric, according to various embodiments;

FIG. 16 is a conceptual illustration of a pair of relevant fixation sequences that satisfy the concurrent gaze metric, according to various embodiments;

FIG. 17 is a conceptual illustration of a pair of relevant fixation sequences that satisfy the recurrent gaze metric, according to various embodiments;

FIG. 18 is a conceptual illustration of relevant fixation sequences that satisfy the single-user gaze metric, according to various embodiments; and

FIG. 19 sets forth a flow diagram of method steps for generating an augmented transcript for a two-user VR session, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### Section I: System Overview

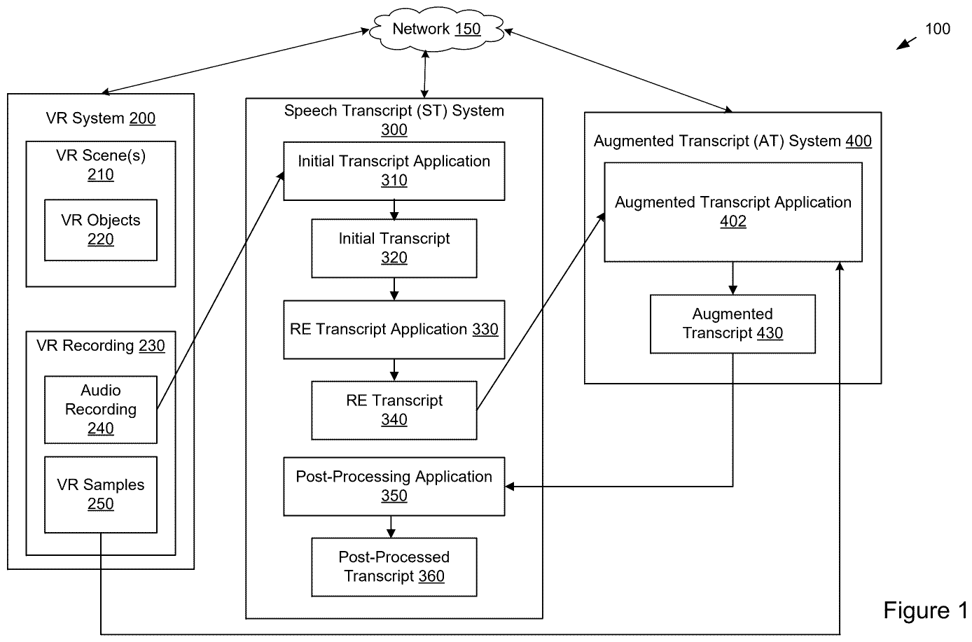

FIG. 1 is a conceptual illustration of a VR transcript system 100 configured to implement one or more aspects of the various embodiments. As shown, in some embodiments, the VR transcript system 100 includes, without limitation, a VR system 200, a speech transcript (ST) system 300, and an augmented transcript (AT) system 400 that are coupled/interconnected together via a network 150.

The network 150 can be any technically feasible set of interconnected communication links, including a local area network (LAN), wide area network (WAN), the World Wide Web, or the Internet, among others. The network 150 enables communications between the VR system 200, ST system 300, and the AT system 400 via wired and/or wireless communications protocols, including Bluetooth, Bluetooth low energy (BLE), wireless local area network (WiFi), cellular protocols, satellite networks, and/or near-field communications (NFC). The network 150 enables communications between the VR system 200, ST system 300, and the AT system 400 to perform the embodiments described herein.

The VR system 200 is configured to generate various VR scenes 210 of a VR environment comprising a plurality of VR objects 220 and enable one or two users to navigate, view, and interact with the VR scenes 210 and VR objects 220 during a VR session. During the VR session, VR system 200 is also configured to generate a recording the VR session (VR session recording 230). The VR session recording 230 includes an audio recording 240 and a set of VR samples 250 of the VR session. The audio recording 240 captures audio of the verbal speech commentary of the one or two users. The set of VR samples 250 comprises samples of VR metadata captured during the entirety of the VR session, including pointing samples and gaze samples of the one or two users.

The pointing samples for a particular user are associated with a laser pointer ray of a VR controller that is controlled by the particular user. A pointing sample can include various metadata including a particular object 220 that is intersected by the laser pointer ray (referred to as the “intersected object” or “target object”) and a timestamp for when the pointing sample was collected during the VR session. The gaze samples for a particular user are associated with a gaze ray function of a VR headset worn by the particular user. A gaze sample can include various metadata including a particular object 220 that is intersected by a gaze ray projected from the VR headset (referred to as the “intersected object” or “target object”) and a timestamp for when the gaze sample was collected during the VR session.

The ST system 300 includes, without limitation, an initial transcript application 310, an RE transcript application 330, and a post-processing transcript application 350. As shown, the initial transcript application 310 of the ST system 300 receives the audio recording 240 from the VR system 200 and generates an initial transcript 320 based on the audio recording 240. The initial transcript 320 comprises a text transcript/conversion of the speech captured in the audio recording 240. As shown, the RE transcript application 330 of the ST system 300 receives the initial transcript 320 from the initial transcript application 310 and generates an RE transcript 340 based on the initial transcript 320. The RE transcript application 330 processes the initial transcript 320 by identifying and marking/indicating each implicit referring expression (RE) in the initial transcript 320 to generate the RE transcript 340.

The AT system 400 includes, without limitation, an augmented transcript application 402. As shown, the augmented transcript application 402 receives the RE transcript 340 from the RE transcript application 330 of the ST system 300 as well as the VR samples 250 from the VR system 200 and generates an augmented transcript 430 based on the RE transcript 340 and the VR samples 250 of the VR session. The RE transcript 340 indicates a plurality of implicit REs that are to be resolved. Each implicit RE is resolved by identifying a particular object 220 of the VR environment that corresponds to the implicit RE and then associating the identified object 220 with the implicit RE in the RE transcript 340 to generate the augmented transcript 430.

The augmented transcript application 402 can first determine, from a set of VR samples 250 that represents the entirety of the VR session, a subset of relevant VR samples that are relevant to a particular implicit RE. The augmented transcript application 402 then identifies a corresponding object 220 for the particular implicit RE based on the subset of relevant VR samples determined to be are relevant to the particular implicit RE. The subset of relevant VR samples 250 can specify a set of candidate objects for a set of behavior metrics, from which a final object can be identified as the object corresponding to the implicit RE by applying a behavior metric hierarchy to the set of candidate objects. The augmented transcript application 402 then associates the identified objects 220 with the corresponding implicit REs in the RE transcript 340 to generate the augmented transcript 430, for example, by specifying/inserting the identified objects 220 adjacent to the corresponding implicit REs in the augmented transcript 430.

As shown, the optional post-processing transcript application 350 of the ST system 300 receives the augmented transcript 430 from the AT system 400 and generates a post-processed transcript 360 based on the augmented transcript 430. For example, the post-processing transcript application 350 can comprise an application that provides a summary of the augmented transcript 430 to generate the post-processed transcript 360. In other embodiments, the systems 200, 300, and/or 400 of FIG. 1 can be implemented as a larger number of systems, or be integrated into a fewer number of systems. In further embodiments, any of the systems 200, 300, and/or 400 of FIG. 1 can be implemented in the cloud as a cloud-based service for clients connected via the network 150.

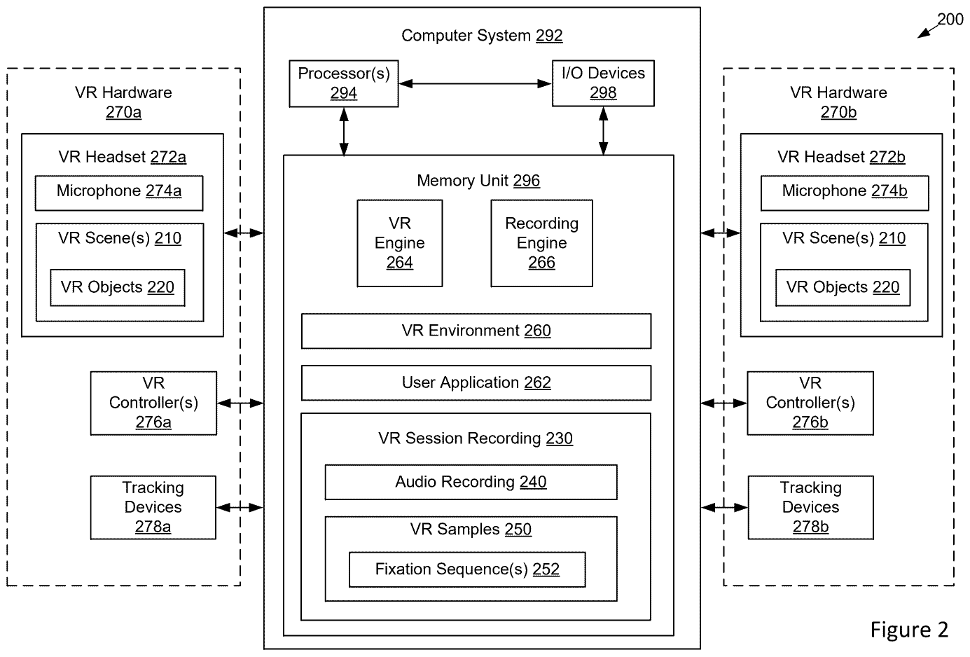

FIG. 2 is a more detailed illustration of the VR system 200 of FIG. 1, according to various embodiments. As shown, the VR system 200 includes, without limitation, a computer system 292 coupled to one or two sets of VR hardware 270 (such as 270a and 270b) for one or two users performing a VR session. The computer system 292 can comprise at least one processor 294, input/output (I/O) devices 298, and a memory unit 296 coupled together via a bus. The computer system 292 can comprise a server, personal computer, laptop or tablet computer, mobile computer system, or any other device suitable for practicing various embodiments described herein. In general, each processor 294 can be any technically feasible processing device or hardware unit capable of processing data and executing software applications and program code. Each processor 294 executes the software and performs the functions and operations set forth in the embodiments described herein. Processor(s) 294 can be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 294 can be any technically feasible hardware unit capable of processing data and/or executing software applications.

The memory unit 296 can include a hard disk, a random access memory (RAM) module, a flash memory unit, or any other type of memory unit or combination thereof. Processor 294 and I/O devices 298 read data from and write data to memory 296. The memory unit 296 stores software application(s) and data. Instructions from the software constructs within the memory unit 296 are executed by processors 294 to enable the inventive operations and functions described herein.

I/O devices 298 are also coupled to memory 296 and can include devices capable of receiving input as well as devices capable of providing output. The I/O devices 298 can include input and output devices not specifically listed in the VR hardware 270, such as a network card for connecting with a network 150, a speaker, a fabrication device (such as a 3D printer), and so forth. Additionally, I/O devices can include devices capable of both receiving input and providing output, such as a touchscreen, a universal serial bus (USB) port, and so forth.

As shown, the computer system 292 is connected to one or two sets of VR hardware 270, such as a first set of VR hardware 270a used by a first user and/or a second set of VR hardware 270b used by a second user during a VR session. Each set of VR hardware 270 includes, without limitation, a VR headset 272 (such as 272a and 272b), one or more VR controllers 276 (such as 276a and 276b), and one or more tracking devices 278 (such as 278a and 278b). Each VR headset 272 can display images in 3D stereo images, such as various VR scenes 210 of a VR environment, each VR scene 210 comprising a plurality of VR objects 220. The VR headset 272 comprises a VR-tracked device that is tracked by the tracking devices 278 that can determine 3D position/location information for the VR headset 272. The tracking devices 278 can track a 3D position of a user viewpoint by tracking the 3D position of the VR headset 272. In some embodiments, the VR headset 272 includes a microphone 274 (such as 274a and 274b) for capturing audio speech by a user of the VR headset 272. In some embodiments, the VR headset 272 also executes a gaze ray function that generates a gaze ray that originates at the VR headset 272 and is projected outward into the current VR scene 210 displayed on the VR headset 272 and can intersect various VR objects 220 within the current VR scene 210. The gaze ray is controllable by the user, via the VR headset 272, and indicates which VR objects 220 in the current VR scene 210 the user is gazing/looking at currently. An object 220 that is currently hit/intersected by the gaze ray is referred to herein as an “intersected object” or a “target object.”

Each VR controller 276 comprises a VR-tracked device that is tracked by the tracking devices 278 that determine 3D position/location information for the VR controller 276. For example, the VR controller 276 can comprise a 6-Degree of Freedom (6DOF) controller that operates in 3D. In some embodiments, the VR controller 276 executes a laser pointer function that generates and displays a laser pointer ray that originates at the VR controller 276 and is projected outward into the current VR scene 210 displayed on the VR headset 272 and can intersect various VR objects 220 within the current VR scene 210. The laser pointer ray is displayed in the VR scene 210 and is controllable by the user, via the VR controller 276, to point at and highlight particular objects 220 in the current VR scene 210. An object 220 that is currently hit/intersected by the laser pointer ray is referred to herein as an “intersected object” or a “target object.”

The memory unit 296 stores a VR engine 264, a recording engine 266, a user application 262, a VR environment 260, and a VR session recording 230. Although shown as separate software components, VR engine 264 and recording engine 266 can be integrated into a single software component. For example, in other embodiments, the recording engine 266 can be integrated with the VR engine 264. In further embodiments, the user application 262 and/or recording engine 266 can be stored and executed on the VR Headset 272.

The user application 262 (as stored in the memory unit 296 and executed by the processor 294 of FIG. 2) can comprise, for example, a 3D design application for creating and/or modifying a 3D design project, such as an architectural design of a room, building, or building site, a mechanical design of a vehicle or other assembly, an electrical design of a computer system, audio system, or other electrical system, or any other type of design project. The 3D design project can be rendered and presented in the VR environment 260. In other embodiments, the user application 262 can comprise any other type of 3D-based application, such as a 3D video game, a 3D data analysis application, and the like, which is presented in the VR environment 260. The VR environment 260 can comprise a 3D virtual environment that is stored, for example, as data describing a current VR scene 210 (such as the 3D position/location, orientation, and names of 3D VR objects 220), data describing a user viewpoint (3D position/location and orientation) in the VR environment 260, data pertinent to the rendering of the current VR scene 210 (such as materials, lighting, and virtual camera location), and the like.

The VR environment 260 is associated with a plurality of VR objects 220 that are displayed in various VR scenes 210 of the VR environment 260. Each VR object 220 comprises a 3D object having associated metadata used to render and display the VR object 220. Metadata for a VR object 220 can also include, without limitation, a name/identifier, a 3D position/location, and an orientation of the VR object 220 within the VR environment 260. A VR environment 260 comprises a plurality of VR scenes 210, each VR scene 210 comprising a sub-portion of the VR environment 260 that is currently displayed in the VR headset 272. The VR engine 264 renders a VR scene 210 comprising a 3D representation of the VR environment 260. The VR scene 210 is then displayed on the VR headset 272. During a VR session, a user can navigate, view, and interact with the VR environment 260 while providing speech/commentary via the VR hardware 270.

In particular, during a VR session, the user can point at particular VR objects 220 in the VR environment 260 using the laser pointer ray of the VR controller 276, while simultaneously providing audio speech/commentary about the particular VR objects 220 via the microphone 274 of the VR headset 272. During the VR session, the user can also gaze/look at particular VR objects 220 in the VR environment 260 by moving the VR headset 272, which points the gaze ray at the particular VR objects 220, while simultaneously providing audio speech/commentary about the particular VR objects 220 via the microphone 274 of the VR headset 272. In some embodiments, a VR session can also include two users, whereby each user separately points at particular VR objects 220 via the VR controller 276, gazes/looks at particular VR objects 220 via the VR headset 272, and provides audio speech/commentary via the microphone 274 of the VR headset 272.

The recording engine 266 (as stored in the memory unit 296 and executed by the processor 294 of FIG. 2) is configured for recording the VR session to generate a VR session recording 230. The VR session recording 230 includes an audio recording 240 and a set of VR samples 250 of the VR session. The audio recording 240 captures audio of the speech/commentary of the one or two users during the VR session. If the VR session includes two users providing speech/commentary via two separate microphones 274, the audio recording 240 includes separately captured audio tracks of the speech/commentary provided by each user via the corresponding microphone 274. For example, the audio recording 240 can comprise an audio file, such as an MP3, WMA, WAV, AAC file, or the like.

The set of VR samples capture the non-verbal behaviors of the one or two users during the VR session. The VR samples 250 capture samples of VR metadata during the entirety of the VR session, including separate pointing samples and gaze samples for each user. For example, the recording engine 266 can generate the VR samples 250 using a 120 Hz sampling rate. In other embodiments, the recording engine 266 can use a different sampling rate. As such, the set of VR samples 250 comprise time series data sampled at a particular rate.

The pointing samples for a particular user are associated with the laser pointer ray of the VR controller 276 that is controlled by the particular user. A pointing sample can include various metadata including a name/identifier of the user (such as “P1” or “P2”), a name/identifier of a particular object 220 that is intersected by the laser pointer ray (the name/identifier of the “intersected object”), and a timestamp of when the pointing sample was taken during the VR session. In general, the pointing samples for a particular user capture which objects 220 in the VR environment 260 the particular user is pointing at with the laser pointer ray while providing commentary during various time points of the VR session.

The gaze samples for a particular user are associated with the projected gaze ray of the VR headset 272 worn by and controlled by the particular user. A gaze sample can include various metadata including a name/identifier of the user (such as “P1” or “P2”), a name/identifier of a particular object 220 that is intersected by the gaze ray (the name/identifier of the “intersected object”), and a timestamp of when the gaze sample was taken during the VR session. The gaze samples for a particular user capture which objects 220 in the VR environment 260 the particular user is looking/gazing at while providing commentary during various time points of the VR session.

In some embodiments, the gaze samples can be generated based on a gaze ray function of two gaze rays that are projected from the VR headset 272. In these embodiments, a gaze ray can be projected/cast from a position of the user's eyes along a direction recorded by built-in eye trackers of the VR headset 272, which can be performed separately for each eye. As such, the two projected gaze rays can incur up to two intersection points within the VR environment 260, in which case a mid-way point between the two intersection points is determined to identify an object 220 at the mid-way point as the intersected object 220 for the gaze rays. If only the projected gaze ray of the left eye intersects with a particular object 220, that particular object is determined to be the intersected object for the gaze rays. If only the projected gaze ray of the right eye intersects with a particular object 220, that particular object is determined to be the intersected object for the gaze rays. However, for the sake of clarity in the embodiments described herein, the gaze ray function is described as projecting a single gaze ray from the VR headset 272 to identify the intersected object 220 for the gaze samples, although in other embodiments two gaze rays can be used.

In some embodiments, the recording engine 266 is further configured to process the set of VR samples 250 of the VR session recording 230 to generate a set of fixation sequences 252 representing the VR session. Each fixation sequence 252 includes a time-continuous sequence of VR samples 250 comprising a minimum threshold number of VR samples 250, wherein each VR sample 250 included in the time-continuous sequence specifies the same name/identifier of a same intersected object. The minimum threshold number of VR samples 250 required in the continuous sequence of VR samples 250 corresponds to a minimum time duration required for a fixation sequence 252. As such, the minimum threshold number of VR samples 250 required for a fixation sequence 252 is based on the minimum time duration and the sampling frequency. In some embodiments, the minimum time duration comprises 100 ms, which corresponds to a minimum number of VR samples 250 equal to 12 (assuming a 120 Hz sampling rate) required for a fixation sequence 252. In other embodiments, a different sampling rate and a different minimum time duration and a different minimum number of VR samples 250 required for a fixation sequence 252 can be used.

Note that each identified fixation sequence 252 comprises a sequence of VR samples associated with either the first user or the second user, but not both users. In addition, each fixation sequence 252 comprises a sequence of VR samples comprising either pointing samples or gaze samples, but not both pointing and gaze samples. Thus, each fixation sequence 252 comprises a sequence of VR samples comprising pointing samples or gaze samples that are associated with the first user or second user.

The recording engine 266 specifies each identified fixation sequence 252 via a fixation tuple that includes the name of a particular VR object 220, a start time of the fixation sequence 252, and an end time of the fixation sequence 252 relative to the start of the VR session (the start of the RE transcript 340). The start time and end time of the fixation sequence 252 specifies a time period of the fixation sequence 252 relative to the start of the VR session (the start of the RE transcript 340). The name of the particular VR object 220 is the name/identifier of the same intersected object specified in each VR sample 250 included in the fixation sequence 252. The start time of the fixation sequence 252 can comprise a first timestamp (earliest timestamp) specified in a first VR sample 250 of the fixation sequence 252. The end time of the fixation sequence 252 can comprise a last timestamp (latest timestamp) specified in a last VR sample 250 of the fixation sequence 252. Note that each fixation sequence 252 will include a number of VR samples 250 that is equal to or greater than the minimum number of VR samples 250 required for a fixation sequence 252. Thus, the start time and the end time of each fixation sequence 252 will specify a time duration that is equal to or greater than the minimum time duration required for a fixation sequence 252.

Any VR samples 250 in the set of VR samples for the VR session that are not included in any fixation sequence 252 are referred to as noisy VR samples 250. In contrast, the fixation sequences 252 include VR samples 250 that are considered meaningful/important VR samples 250. In this manner, the recording engine 266 can separate out the meaningful/important data samples from noisy data samples in the VR set of samples 250 of the VR session recording 230. In general, a fixation sequence 252 indicates a pointing or gaze fixation/focus of a user on a single VR object 220 for a minimum time duration to be considered a meaningful pointing or gaze and not be considered as noise.

In some embodiments, the recording engine 266 represents the set of VR samples 250 of the VR session via a set of fixation tuples representing the a set of fixation sequences 252. In these embodiments, the augmented transcript application 402 of the AT system 400 receives and processes the fixation sequences 252 and fixation tuples to generate the augmented transcript 430. In other embodiments, the recording engine 266 does not further process the set of VR samples 250 to identify the set of fixation sequences 252, but rather the augmented transcript application 402 of the AT system 400 performs this function. In these embodiments, the augmented transcript application 402 of the AT system 400 receives the set of VR samples 250 for the VR session from the VR system 200, identifies a set of fixation sequences 252 included in the VR samples 250, and generates a fixation tuple for each identified fixation sequence 252. The augmented transcript application 402 then processes the set of fixation sequences 252 and corresponding set of fixation tuples to generate the augmented transcript 430.

In further embodiments, an “alternative VR metadata” process is performed whereby the VR samples 250 generated by the recording engine 266 include different VR metadata than described above. In particular, each VR sample 250 generated by the recording engine 266 does not specify the intersected object 220. In these embodiments, each pointing sample generated by the recording engine 266 includes VR metadata comprising 3D coordinates for an origin of the laser pointer ray in the VR environment 260, a 3D vector representing the direction of the laser pointer ray in the VR environment 260, and a timestamp. Likewise, each gaze sample generated by the recording engine 266 includes VR metadata comprising 3D coordinates for an origin of the gaze ray in the VR environment 260, a 3D vector representing the direction of the gaze ray in the VR environment 260, and a timestamp. In these embodiments, the augmented transcript application 402 receives all such VR samples 250 for the VR session from the VR system 200 and, for each VR sample, the augmented transcript application 402 identifies an intersected object 220 associated with the VR sample. For example, the augmented transcript application 402 can do so by analyzing the positions of the VR objects 220 in the VR environment 260 to determine an intersected object for each VR sample based on the metadata specified in the VR sample. The augmented transcript application 402 can then identify fixation sequences 252 included in the VR samples 250, and generate a fixation tuple for each identified fixation sequence 252. The augmented transcript application 402 then processes the fixation sequences 252 and corresponding fixation tuples to generate the augmented transcript 430.

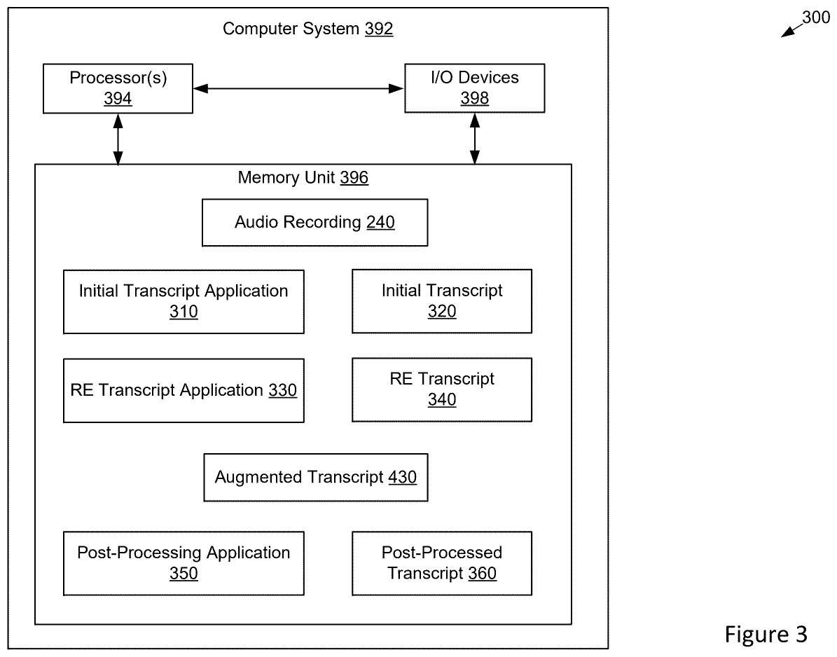

FIG. 3 is a more detailed illustration of the speech transcript (ST) system 300 of FIG. 1, according to various embodiments. As shown, the ST system 300 includes, without limitation, a computer system 392. The computer system 392 can comprise at least one processor 394, input/output (I/O) devices 398, and a memory unit 396 coupled together via a bus. The processor(s) 394, input/output (I/O) devices 398, and memory unit 396 are similar to the processor(s) 294, input/output (I/O) devices 298, and memory unit 296, respectively, of the computer system 292 of FIG. 2, and thus are not discussed in detail here. The memory unit 396 stores an initial transcript application 310, an RE transcript application 330, an optional post-processing transcript application 350, the audio recording 240, the initial transcript 320, the RE transcript 340, the augmented transcript 430, and the post-processed transcript 360.

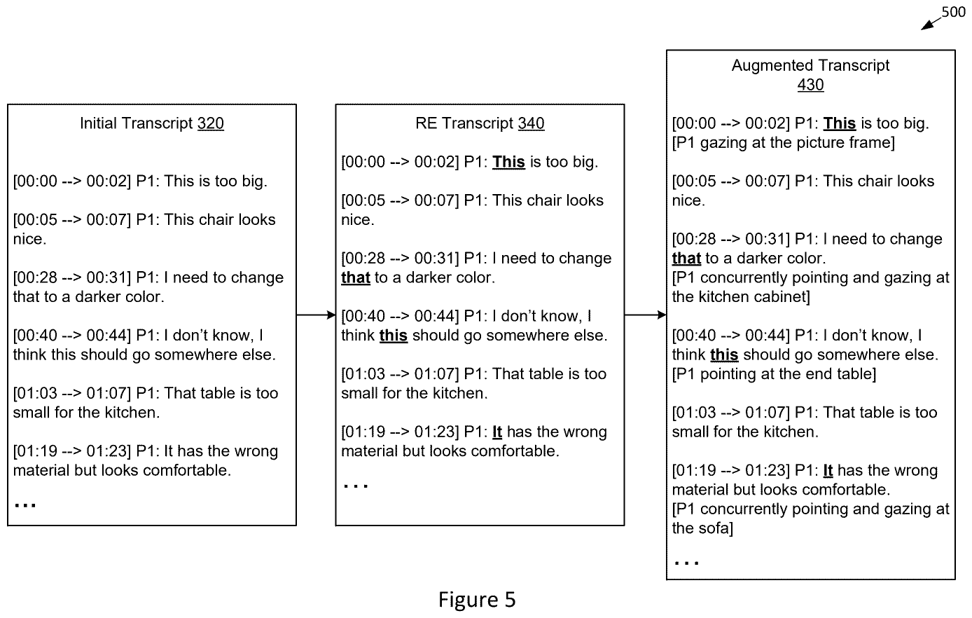

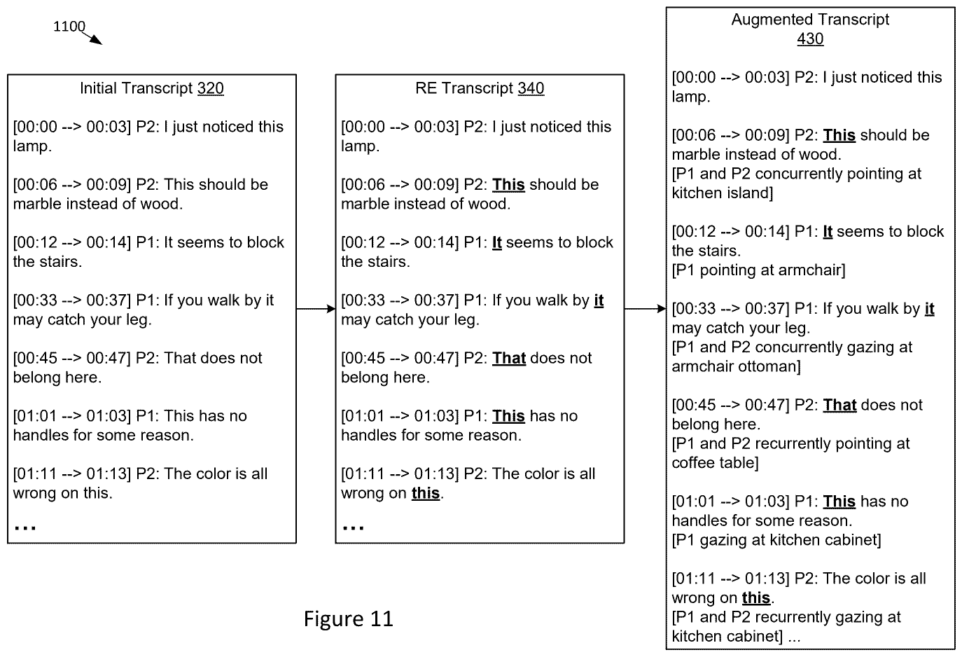

In operation, the initial transcript application 310 (as stored in the memory unit 396 and executed by the processor 394) receives and stores the audio recording 240 from the VR system 200 and generates an initial transcript 320 based on the audio recording 240. The initial transcript 320 comprises a text transcript of the speech captured in the audio recording 240. The initial transcript 320 can include timestamps or time ranges associated with each word or sentence in the initial transcript 320, as well as an identification/name of the particular user/speaker that uttered/spoke the particular word or sentence. For a two-user VR session, each user's audio track is transcribed separately, thus preserving user/speaker identity and enabling speaker diarization (partitioning an audio recording of speech into homogeneous segments according to the identity of each user/speaker). The separate transcriptions are then merged into the single initial transcript 320, while appending user/speaker identifiers to each sentence and arranging the sentences chronologically. The resulting initial transcript 320 includes temporal timestamps for each word and sentence, along with speaker identity information. An example of an initial transcript 320 for a single user is discussed below in relation to FIG. 5. An example of an initial transcript 320 for two users is discussed below in relation to FIG. 11.

The RE transcript application 330 (as stored in the memory unit 396 and executed by the processor 394) receives the initial transcript 320 from the initial transcript application 310 and generates an RE transcript 340 based on the initial transcript 320. The RE transcript application 330 processes the initial transcript 320 by identifying and marking/indicating each implicit RE in the initial transcript 320 to generate the RE transcript 340. As such, the RE transcript 340 comprises the initial transcript 320, but with each word comprising an implicit RE in the initial transcript 320 being marked/highlighted in some manner to indicate that the word is an implicit RE that is to be resolved by the AT system 400. An example of an RE transcript 340 for a single user is discussed below in relation to FIG. 5. An example of an RE transcript 340 for two users is discussed below in relation to FIG. 11.

To generate the RE transcript 340 based on the initial transcript 320, the RE transcript application 330 first identifies all spatial REs, then classifies each spatial RE as either a spatial explicit RE or a spatial implicit RE, and then marks each spatial implicit RE (referred to as an implicit RE herein) in the initial transcript 320 to generate the RE transcript 340. To identify the spatial REs, the RE transcript application 330 identifies REs related to objects in a given sentence, while excluding REs where the referent is a person (such as you, me, we, guests) or are temporal REs (such as now, then, today, tomorrow). The RE transcript application 330 then analyzes each sentence that includes a spatial RE. If the sentence includes the noun/object that the spatial RE refers to is within the same sentence, the spatial RE comprises a spatial explicit RE. Otherwise, the spatial RE comprises a spatial implicit RE, each spatial implicit RE being marked/indicated in the initial transcript 320 to generate the RE transcript 340. An example of a spatial explicit RE is “This coach looks comfortable.” An example of a spatial implicit RE is “This does not look comfortable.” In general, examples of a spatial implicit RE include “this,” “that,” “these,” “those,” “it,” and the like. The RE transcript application 330 then processes the spatial explicit REs to resolve each spatial explicit RE to generate the RE transcript 340. However, the RE transcript application 330 does not process the spatial implicit REs, and rather the augmented transcript application 402 processes and resolves the spatial implicit REs (referred to as an implicit RE herein) that are marked/indicated in the RE transcript 340 to generate the augmented transcript 430.

The post-processing transcript application 350 (as stored in the memory unit 396 and executed by the processor 394) receives and stores the augmented transcript 430 from the AT system 400 and generates a post-processed transcript 360 based on the augmented transcript 430. For example, the post-processing transcript application 350 can comprise an application that provides a summary of the augmented transcript 430, extracts specific information and/or insights from the augmented transcript 430, supports data-driven decisions, and the like for generating the post-processed transcript 360.

In other embodiments, any of the applications (initial transcript application 310, RE transcript application 330, or optional post-processing transcript application 350) of the ST system 300 of FIG. 3 can be executed on separate systems. In further embodiments, any of the applications 310, 330, or 350 of FIG. 3 can be implemented in the cloud as a cloud-based service for clients connected via the network 150. In some embodiments, any of the applications (initial transcript application 310, RE transcript application 330, and/or optional post-processing transcript application 350) of the ST system 300 of FIG. 3 can be implemented as an artificial machine learning model that is trained using machine learning techniques that train the neural networks included in the machine learning model to perform the various functions of any of the applications 310, 330, and/or 350. For example, any of the applications (initial transcript application 310, RE transcript application 330, and/or optional post-processing transcript application 350) of the ST system 300 can be implemented as a large language model (LLM) that is trained for natural language processing tasks, such as language generation or any of the various functions of any of the applications 310, 330, and/or 350 as described herein. For example, the LLM implemented for any of the applications 310, 330, and/or 350 can comprise a generative pretrained transformers (GPT) trained for natural language processing and to perform any of the various functions of any of the applications 310, 330, and/or 350 as described herein.

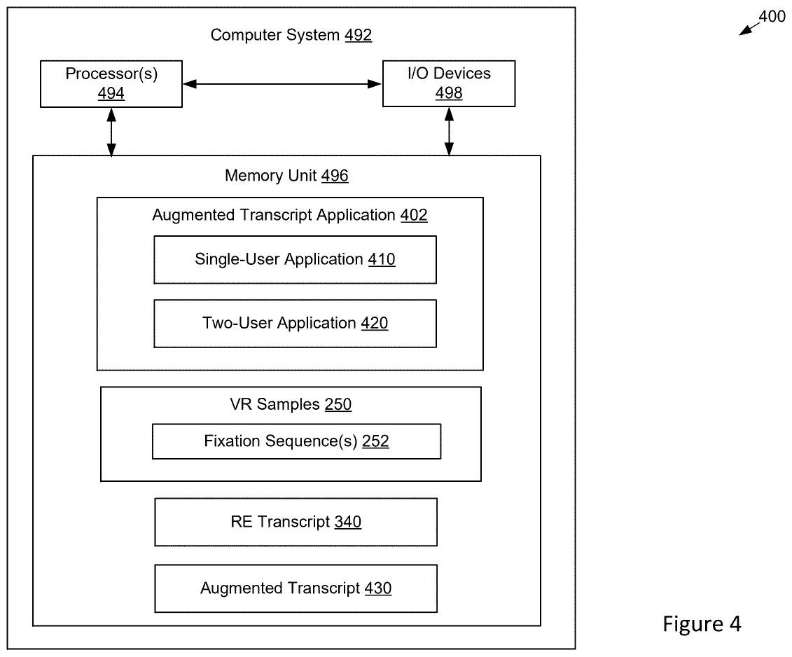

FIG. 4 is a more detailed illustration of the augmented transcript (AT) system 400 of FIG. 1, according to various embodiments. As shown, the AT system 400 includes, without limitation, a computer system 492. The computer system 492 can comprise at least one processor 494, input/output (I/O) devices 498, and a memory unit 496 coupled together via a bus. The processor(s) 494, input/output (I/O) devices 498, and memory unit 496 are similar to the processor(s) 294, input/output (I/O) devices 298, and memory unit 296, respectively, of the computer system 292 of FIG. 2, and thus are not discussed in detail here. The memory unit 496 stores an augmented transcript application 402, the set of VR samples 250, the RE transcript 340, and the augmented transcript 430.

In operation, the augmented transcript application 402 (as stored in the memory unit 496 and executed by the processor 494) receives and stores the set of VR samples 250 from the VR system 200, receives and stores the RE transcript 340 from the ST system 300, and generates an augmented transcript 430 based on the RE transcript 340 and the set of VR samples 250. In particular, the RE transcript 340 indicates a plurality of implicit REs that are to be resolved. Each implicit RE is resolved by identifying a particular object 220 of the VR environment 260 that corresponds to the implicit RE and associating the identified object 220 with the implicit RE in the augmented transcript 430. The augmented transcript application 402 identifies a corresponding object 220 for an implicit RE based on VR samples 250 (including pointing and gaze samples) that are determined to be relevant to the implicit RE. The VR samples 250 relevant to a particular implicit RE can specify one or more intersected objects from which a particular object can be selected/identified as the final object corresponding to the implicit RE. The augmented transcript application 402 then associates the selected/identified objects 220 with the corresponding implicit REs in the RE transcript 340 to generate the augmented transcript 430. As such, the augmented transcript 430 comprises the RE transcript 340, but with each marked implicit RE in the RE transcript 340 being associated with a particular object 220 of the VR environment 260.

The memory unit 496 stores an augmented transcript application 402 comprising a single-user application 410 and a two-user application 420. The single-user application 410 is used to process VR samples 250 and an RE transcript 340 that are based on a VR session that is executed/performed by a single user to generate the augmented transcript 430. The single-user application 410 is discussed in detail below in Section II. The two-user application 420 is used to process VR samples 250 and an RE transcript 340 that are based on a VR session that is executed/performed by two users to generate the augmented transcript 430. The two-user application 420 is discussed in detail below in Section III.

In some embodiments, the augmented transcript application 402 receives (such as via the network 150) the set of the VR samples 250 of the VR session from the VR system 200. In these embodiments, the augmented transcript application 402 processes the set of VR samples 250 to identify a set of fixation sequences 252 included in the VR samples 250 and generate a fixation tuple for each identified fixation sequence 252, as discussed above in relation to FIG. 2. The augmented transcript application 402 then resolves each implicit RE in the RE transcript 340 based on the set of fixation sequences 252 and the corresponding set of fixation tuples. In other embodiments, the augmented transcript application 402 of the AT system 400 receives (such as via the network 150) the set of fixation sequences 252 and corresponding set of fixation tuples from the VR system 200 to generate the augmented transcript 430.

In some embodiments, the augmented transcript application 402 resolves the implicit REs that are marked in the RE transcript 340 via an iterative RE resolution technique. For each iteration, the RE resolution technique resolves an implicit RE by determining an RE time window for the implicit RE and identifying a subset of relevant fixation sequences 252 relevant to the implicit RE based on the RE time window. The subset of relevant fixation sequences 252 are identified from the set of fixation sequences 252 for the VR session and thus comprises a sub-portion of the set of fixation sequences 252 for the VR session. The RE resolution technique further identifies 0 or 1 candidate objects 220 for each of a plurality of non-verbal behavior metrics based on the subset of relevant fixation sequences 252, and applies a metric hierarchy algorithm to the candidate objects 220 of the plurality of non-verbal behavior metrics to identify a “final” object 220 that is selected to correspond to and resolve the implicit RE. The augmented transcript application 402 then associates each “final” object 220 with the corresponding implicit RE in the RE transcript 340 to generate the augmented transcript 430. For example, the augmented transcript application 402 can specify/insert and display the name/identifier of the “final” object 220 adjacent to the corresponding implicit RE in the RE transcript 340 to generate the augmented transcript 430.

In some embodiments, the RE time window for an implicit RE can be determined based on a timestamp associated with the implicit RE in the RE transcript 340. The RE transcript 340 can include a timestamp for each word in the RE transcript 340, the timestamp indicating the time that the word was uttered/spoken relative to the start of the VR session (the start of the RE transcript 340). The RE time window can be based on a predetermined time period relative to the timestamp of the implicit RE. For example, the RE time window can be a time period of X seconds before the timestamp of the implicit RE and Y seconds after the timestamp of the implicit RE, where X can be equal or not equal to Y. In other embodiments, the RE time window can be based on a predetermined number of sentences or words relative to the position of the implicit RE within the RE transcript 340. For example, the RE time window can be a time period corresponding to the start and end of a sentence that includes the implicit RE in the RE transcript 340. Here, the start of the RE time window would correspond to the timestamp of the first word in this sentence and the end of the RE time window would correspond to the timestamp of the last word in this sentence. For example, the RE time window can be a time period corresponding to X sentences before the sentence that includes the implicit RE and Y sentences after the sentence that includes the implicit RE in the RE transcript 340, where X can be equal or not equal to Y. For example, the RE time window can be a time period corresponding to X words before the implicit RE and Y words after the implicit RE in the RE transcript 340, where X can be equal or not equal to Y.

In some embodiments, the user can configure the RE time window based on a predetermined time period, a predetermined number of sentences, or a predetermined number of words relative to the timestamp or position of the implicit RE within the RE transcript 340 in order to find an optimal RE time window for the user's purposes. In these embodiments, the user can select any number of the above examples for configuring the RE time window to find the optimal RE time window that provides the most accurate RE resolutions.

The augmented transcript application 402 then identifies, from the set of fixation sequences 252, the subset of relevant fixation sequences 252 that are determined to be associated with/relevant to the implicit RE based on the RE time window. Each fixation sequence 252 is specified via a fixation tuple that includes the name of an object 220, a start time of the fixation sequence 252, and an end time of the fixation sequence 252 relative to the start of the VR session (the start of the RE transcript 340). The start time and end time of the fixation sequence 252 specifies a time period of the fixation sequence 252 relative to the start of the VR session (the start of the RE transcript 340). The augmented transcript application 402 can identify each fixation sequence 252 having an associated time period that at least overlaps (by any time amount) the RE time window as a relevant fixation sequence 252 to be included in the subset of relevant fixation sequences 252. In other embodiments, a minimum threshold time amount of overlap is required with the RE time window.

The augmented transcript application 402 then identifies 0 or 1 candidate objects 220 for each of a plurality of non-verbal behavior metrics based on the subset of relevant fixation sequences 252. The single-user application 410 implements a first plurality of behavior metrics for a VR session performed by a single user. The two-user application 420 implements a second plurality of behavior metrics for a VR session performed by two users. In some embodiments, the first plurality of behavior metrics is different from the second plurality of behavior metrics. In some embodiments, the first plurality of behavior metrics for a single user comprises a concurrent pointing and gaze metric, a pointing metric, and a gaze metric. In some embodiments, the second plurality of behavior metrics for two users comprises a concurrent pointing metric, recurrent pointing metric, a single-user pointing metric, a concurrent gaze metric, a recurrent gaze metric, and a single-user gaze metric.

For each behavior metric, the augmented transcript application 402 determines if any relevant fixation sequences 252 matches/satisfies the behavior metric, and if so, identifies nominee objects 220 from the matching fixation sequences 252. If two or more nominee objects 220 are identified, then the augmented transcript application 402 calculates a proportion value for each nominee object 220 and selects the nominee object 220 having the highest proportion value as the candidate object 220 for the particular behavior metric. The proportion value for a particular nominee object 220 represents/indicates a time percentage/proportion of the RE time window that the particular nominee object 220 was an object of fixation by the user. If no relevant fixation sequences 252 are found to match/satisfy the behavior metric, then there is no candidate object 220 selected for the behavior metric.

The augmented transcript application 402 then applies a metric hierarchy algorithm to the candidate objects 220 of the plurality of non-verbal behavior metrics to identify a “final” object 220 that is selected to correspond to and resolve the implicit RE. The single-user application 410 implements a first metric hierarchy algorithm for a VR session performed by a single user. The two-user application 420 implements a second metric hierarchy algorithm for a VR session performed by two users. In some embodiments, the first metric hierarchy is different from the second metric hierarchy. The first metric hierarchy and the second metric hierarchy follow the general ideas that concurrent or recurrent behavior provides the most accurate RE resolution, then single-user pointing behavior provides the second-most accurate RE resolution, and then single-user gaze behavior provides the third-most accurate RE resolution. Even though the gaze behavior provides the least accurate RE resolution, experimentation has shown that use of gaze behavior still provides significantly more accurate RE resolution results than conventional RE resolution techniques that do not consider non-verbal behaviors for RE resolution.

In addition, experimentation has shown that pointing behavior is more accurate and useful than gaze behavior, as pointing is a deliberate action requiring effort and strongly indicates intention and attention of the user. In contrast, gaze behavior can be more reflexive and influenced by various factors other than intention and attention of the user. Thus, pointing behavior can be prioritized over gaze behavior in the first and second metric hierarchies. In addition, experimentation has shown that synergistic behaviors are more accurate and useful than individual/separate behavior. For example, for a single-user VR session, the synergistic concurrent pointing and gaze behavior of the single user is found to be more accurate and useful for RE resolution than individual pointing behavior and individual gaze behavior. For example, for a two-user VR session, the synergistic concurrent or recurrent pointing or gaze behavior of both users is found to be more accurate and useful for RE resolution than single-user pointing or gaze behavior.

In particular, experimentation with the first metric hierarchy has shown that for a single user performing the VR session, concurrent/simultaneous pointing and gaze behavior of the single user that targets a same intersected object 220 (if this behavior is found to occur) provides the most accurate RE resolution. Experimentation has also shown that pointing behavior of the single user that targets an intersected object 220 (if this behavior is found to occur) provides the second-most accurate RE resolution, and then gaze behavior of the single user that targets an intersected object 220 (if this behavior is found to occur) provides the third-most accurate RE resolution. Even though the gaze behavior provides the least accurate RE resolution, use of the gaze behavior still provides significantly more accurate RE resolution results than conventional RE resolution techniques that do not consider non-verbal behaviors for RE resolution. As such, in some embodiments, the first metric hierarchy for a single user comprises a ranking order of the first plurality of behavior metrics comprising the concurrent pointing and gaze metric at the top of the first metric hierarchy, then a pointing metric, and then a gaze metric at the bottom of the first metric hierarchy.

In addition, experimentation with the second metric hierarchy has shown that for two users performing the VR session, concurrent pointing behavior of both users that simultaneously targets a same intersected object 220 (if this behavior is found to occur) provides the most accurate RE resolution, then recurrent pointing behavior of both users that targets a same intersected object 220 (if this behavior is found to occur) provides the second-most accurate RE resolution, then pointing behavior of a single user that targets an intersected object 220 (if this behavior is found to occur) provides the third-most accurate RE resolution, then concurrent gaze behavior of both users that simultaneously targets a same intersected object 220 (if this behavior is found to occur) provides the fourth-most accurate RE resolution, then recurrent gaze behavior of both users that targets a same intersected object 220 (if this behavior is found to occur) provides the fifth-most accurate RE resolution, and then gaze behavior of a single user that targets an intersected object 220 (if this behavior is found to occur) provides the sixth-most accurate RE resolution. Even though the gaze behavior of the single user provides the least accurate RE resolution, use of the single user gaze behavior still provides significantly more accurate RE resolution results than conventional RE resolution techniques that do not consider non-verbal behaviors for RE resolution. As such, in some embodiments, the second metric hierarchy for two users comprises a ranking order of the second plurality of behavior metrics comprising the concurrent pointing metric at the top of the second metric hierarchy, then a recurrent pointing metric, then a single-user pointing metric, then a concurrent gaze metric, then a recurrent gaze metric, and then a single-user gaze metric at the bottom of the second metric hierarchy.

After applying the metric hierarchy to select the final object 220 for the corresponding implicit RE, the augmented transcript application 402 then associates each final object 220 with the corresponding implicit RE in the RE transcript 340 to generate the augmented transcript 430. In some rare cases, an implicit RE can have no final object 220 that is found to correspond to the implicit RE. In these cases, the implicit RE is not resolved by the AT system 400.

### Section II: Single-User VR Session

In some embodiments, the VR session is executed/performed by a single user, whereby the audio recording 240 and set of VR samples 250 of the VR session recording 230 (and the set of fixation sequences 252) relate only to the single user. Therefore, the initial transcript application 310 generates an initial transcript 320, the RE transcript application 330 generates an RE transcript 340, and the single-user application 410 of the augmented transcript application 402 generates the augmented transcript 430 based on the single-user VR session.

FIG. 5 is a conceptual illustration of a set of single-user transcripts 500 generated for a single-user VR session, according to various embodiments. As shown, the set of single-user transcripts 500 includes an example initial transcript application 310, an example RE transcript 340, and an example augmented transcript 430. Each transcript 310, 340, and/or 430 can be generated and displayed to the user via a user interface displayed on a monitor, touchscreen, VR headset, or the like.

The initial transcript 320 comprises a text transcript conversion of the speech of the single user as captured in the audio recording 240 during the VR session. The initial transcript 320 can include timestamps or time ranges associated with each word or sentence in the initial transcript 320, the timestamps or time ranges being relative to the start of the VR session (start of the initial transcript 320). As shown, the initial transcript 320 displays time ranges associated with each sentence in the initial transcript 320. The initial transcript 320 can also include embedded timestamps associated with each word that is not displayed in the initial transcript 320 for the sake of clarity. As shown, the single user who is identified as “P1” is indicated as the speaker of each sentence in the initial transcript 320.

As shown, the RE transcript 340 comprises the initial transcript 320 but with implicit REs in the initial transcript 320 being visually marked/indicated in some manner. In some embodiments, each implicit RE is visually highlighted in some manner in the RE transcript 340, such as using a different textual font, color, and/or typeface (bold, underline, italics) than the other normal words (non-implicit REs) in the RE transcript 340. As shown in the example of FIG. 5, the implicit REs are underlined and bolded to visually distinguish the implicit REs from the other normal words (non-implicit REs) in the RE transcript 340. In other embodiments, each implicit RE is visually highlighted using a graphical indicator, such as a rectangle or circle displayed around the implicit RE in the RE transcript 340.

As shown, the augmented transcript 430 comprises the RE transcript 340 but with the implicit REs being resolved in the augmented transcript 430. Each resolved implicit RE has a corresponding VR object 220, whereby the augmented transcript 430 visually indicates in some manner a correspondence/association between the resolved implicit RE and the corresponding VR object 220. In some embodiments, the name/identifier of the object 220 can be specified/inserted and displayed adjacent to the corresponding resolved implicit RE in the augmented transcript 430, such as being displayed within text brackets or within a graphical box with an arrow pointing to the corresponding resolved implicit RE, and the like. In some embodiments, the behavior metric associated with the corresponding VR object 220 that was used to select the corresponding VR object 220 via the metric hierarchy can also be inserted/displayed in the augmented transcript 430. As shown in the example of FIG. 5, for each resolved implicit RE, the augmented transcript 430 inserts/displays the user identifier “P1,” the associated behavior metric, and the name of the corresponding VR object 220 adjacent to the resolved implicit RE in the augmented transcript 430 (such as “P1 concurrently pointing and gazing at the sofa” being displayed adjacent to “It”). In further embodiments, the proportion values previously calculated for the corresponding VR object 220 and/or one or more nominee or candidate objects 220 can also be inserted/displayed adjacent to the name of the corresponding VR object 220 in the augmented transcript 430 (such as “P 1 was pointing at the fridge 25% of the time and the sofa 75% of the time”).

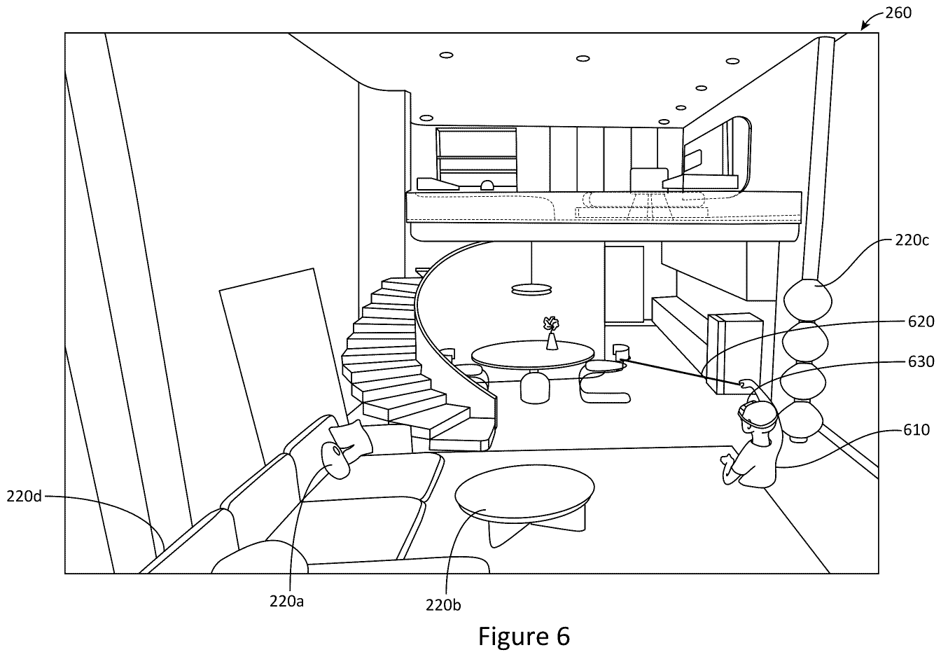

FIG. 6 is a conceptual illustration of a single-user VR session in a VR environment 260, according to various embodiments. In the VR system 200, the VR environment 260 is rendered by the VR engine 264 and displayed in the VR headset 272 worn by the single user during the VR session. As shown, the displayed VR environment 260 includes a 3D architectural design model of an apartment comprising a plurality of VR objects 220 (such as 220a, 220b, 220c, 220d, etc.). In other embodiments, the VR environment 260 includes any other type of 3D design model. The displayed VR environment 260 also includes a user avatar 610, a laser pointer ray 620, and a VR headset avatar 630. The base of the laser pointer ray 620 can also be considered a VR controller avatar.

During a VR session, the single user can navigate the VR environment 260 and interact with the VR objects 220 via the VR controller 276, while providing speech/commentary via the microphone 274 of the VR headset 272. The VR controller 276 controls the laser pointer ray 620 which can be pointed to particular VR objects 220 to intersect the particular VR objects 220 with the laser pointer ray 620. The user also controls the movement of the VR headset 272, which controls the movement of the VR headset avatar 630 displayed in the VR environment. In this manner, the user controls a gaze ray that is projected (but not displayed) from the VR headset avatar 630 to particular VR objects 220 which intersect the particular VR objects 220.

During the VR session, the recording engine 140 generates an audio recording 240 of the speech/commentary provided by the single user and VR samples 250 (pointing and gaze samples) describing the non-verbal behaviors of the single user. To generate a pointing sample at a particular time point in the VR session, the recording engine 140 determines a name of a VR object 220, if any, that is intersected by the laser pointer ray 620 and a timestamp corresponding to the particular time point in the VR session, the pointing sample including the name of the intersected VR object 220 and the timestamp. To generate a gaze sample at a particular time point in the VR session, the recording engine 140 determines a name of a VR object 220, if any, that is intersected by the gaze ray projected (but not displayed) from the VR headset avatar 630 and a timestamp corresponding to the particular time point in the VR session, the gaze sample including the name of the intersected VR object 220 and the timestamp.

After the VR session is completed and an initial transcript 320 and RE transcript 340 is generated for the VR session based on the audio recording, the set of fixation sequences 252 from the set of VR samples 250 is determined by the VR system 200 or the AT system 400. The set of fixation sequences 252 can include fixation sequences 252 comprising pointing samples and fixation sequences 252 comprising gaze samples. For each implicit RE indicated in the RE transcript 340, the single-user application 410 of the augmented transcript application 402 determines an RE time window for the implicit RE and a subset of relevant fixation sequences 252 from the overall set of fixation sequences 252 based on the RE time window. The subset of fixation sequences 252 can include relevant fixation sequences 252 comprising pointing samples and relevant fixation sequences 252 comprising gaze samples.

The single-user application 410 then identifies 0 or 1 candidate objects 220 for each of a first plurality of behavior metrics based on the subset of relevant fixation sequences 252. In some embodiments, the first plurality of behavior metrics for a single user comprises a concurrent pointing and gaze metric, a pointing metric, and a gaze metric. For each behavior metric, the single-user application 410 determines if one or more relevant fixation sequences 252 matches/satisfies the behavior metric, and if so, identifies nominee objects 220 from the matching fixation sequences 252. If two or more nominee objects 220 are identified from the subset of relevant fixation sequences 252, then the single-user application 410 calculates a proportion value for each nominee object 220 and selects the nominee object 220 having the highest proportion value as the candidate object 220 for the particular behavior metric.

In general, the concurrent pointing and gaze metric is satisfied when two conditions are met by a pair of relevant fixation sequences 252: 1) a first relevant fixation sequence 252 comprising pointing samples overlaps in time (by any time amount) with a second relevant fixation sequence 252 comprising gaze samples, and 2) the first relevant fixation sequence 252 and the second relevant fixation sequence 252 both specify the same intersected object 220. In other embodiments, a minimum threshold time amount of overlap is required. Note that both the above conditions need to be satisfied for the concurrent pointing and gaze metric to be satisfied by the first relevant fixation sequence 252 and the second relevant fixation sequence 252.

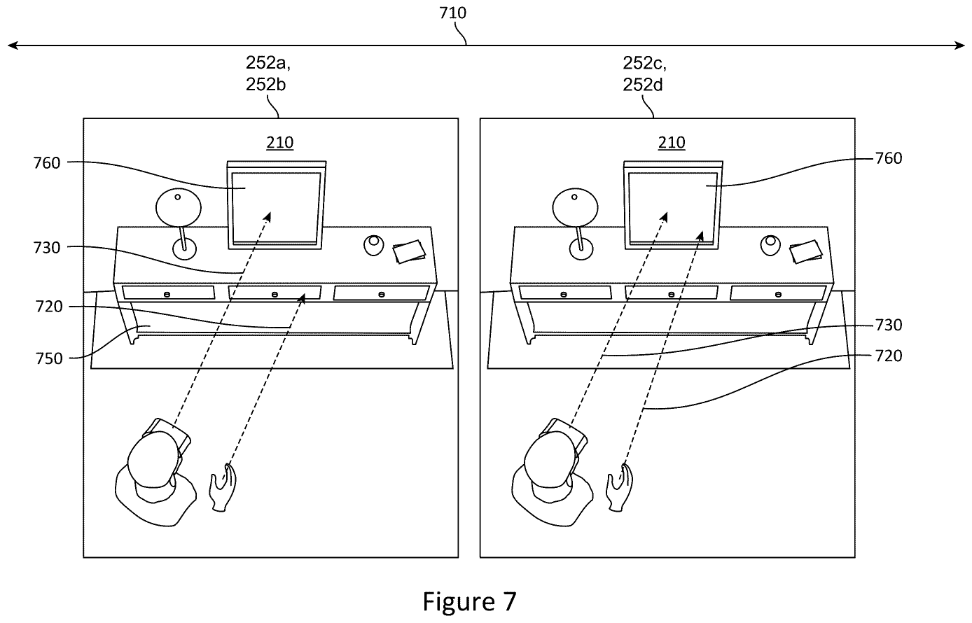

FIG. 7 is a conceptual illustration of a pair of relevant fixation sequences 252 that satisfy the concurrent pointing and gaze metric, according to various embodiments. FIG. 7 shows conceptual illustrations of a VR scene 210 corresponding to various relevant fixation sequences 252 (such as 252a, 252b, 252c, and 252d) that each overlap an RE time window 710. Note that in the example of FIG. 7, only a portion of the subset of relevant fixation sequences 252 that overlap the RE time window 710 is shown, and the subset of relevant fixation sequences 252 can include other relevant fixation sequences 252 than those shown in FIG. 7.

As shown, a first relevant fixation sequence 252a comprises a sequence of pointing samples that each specify a first object 750 (cabinet) in a VR scene 210 that is intersected by a laser pointer ray 720. A second relevant fixation sequence 252b comprises a sequence of gaze samples that each specify a second object 760 (picture frame) in the VR scene 210 that is intersected by a gaze ray 730. The first relevant fixation sequence 252a comprising pointing samples overlaps in time with the second relevant fixation sequence 252b comprising gaze samples, which satisfies the first condition. However, the first relevant fixation sequence 252a and the second relevant fixation sequence 252b do not both specify the same intersected object 220, which does not satisfy the second condition. Thus, the first relevant fixation sequence 252a and the second relevant fixation sequence 252b do not satisfy the concurrent pointing and gaze metric.

As shown, a third relevant fixation sequence 252c comprises a sequence of pointing samples that each specify the second object 760 (picture frame) in the VR scene 210 that is intersected by the laser pointer ray 720. A fourth relevant fixation sequence 252d comprises a sequence of gaze samples that each specify the second object 760 (picture frame) in the VR scene 210 that is intersected by the gaze ray 730. Thus, the third relevant fixation sequence 252c comprising pointing samples overlaps in time with the fourth relevant fixation sequence 252d comprising gaze samples (which satisfies the first condition), and the third relevant fixation sequence 252c and the fourth relevant fixation sequence 252d both specify the same intersected object 220 (the picture frame 760), which satisfies the second condition. Thus, the third relevant fixation sequence 252c and the fourth relevant fixation sequence 252d satisfy the concurrent pointing and gaze metric. Therefore, the same intersected object 220 (the picture frame 760) is identified as a first nominee object 220 for the concurrent pointing and gaze metric. If only one nominee object 220 is identified for the concurrent pointing and gaze metric based on the subset of relevant fixation sequences 252, then the one nominee object 220 comprises the candidate object 220 selected for the concurrent pointing and gaze metric.

However, if other pairs of relevant fixation sequence 252 within the subset of relevant fixation sequences 252 and the RE time window 710 satisfy the concurrent pointing and gaze metric, then one or more additional nominee objects 220 can be identified for the concurrent pointing and gaze metric. For example, a fifth relevant fixation sequence 252e (not shown) can comprise a sequence of pointing samples that each specify a third object (lamp) in the VR scene 210 and overlaps in time a sixth relevant fixation sequence 252f (not shown) comprising a sequence of gaze samples that each specify the same third object (lamp) in the VR scene 210. Thus, the fifth relevant fixation sequence 252e and the sixth relevant fixation sequence 252f also satisfy the concurrent pointing and gaze metric and the third object (lamp) is identified as a second nominee object 220 for the concurrent pointing and gaze metric.

If two or more nominee objects 220 are identified for a behavior metric, then the single-user application 410 calculates a proportion value for each nominee object 220 and selects the nominee object 220 having the highest proportion value as the candidate object 220 for the particular behavior metric. The proportion value for a particular nominee object 220 represents/indicates a time percentage/proportion of the RE time window 710 that the particular nominee object 220 was an object of fixation by the user. In some embodiments, the proportion value for a nominee object 220 of the concurrent pointing and gaze metric is determined by dividing the time duration of fixation overlap for the nominee object 220 during the RE time window by the total duration of the RE time window, which is then multiplied by 100. Thus, the proportion value for a nominee object 220 indicates a percentage/proportion of fixation overlap time of the nominee object 220 during the RE time window.

For example, the time duration of fixation overlap for the first nominee object 220 (picture frame) would comprise the amount of time overlap between the third relevant fixation sequence 252c and the fourth relevant fixation sequence 252d during the RE time window, which can be determined using the fixation tuples specified for the third relevant fixation sequence 252c and the fourth relevant fixation sequence 252d. Likewise, the time duration of fixation overlap for the second nominee object 220 (lamp) would comprise the amount of time overlap between the fifth relevant fixation sequence 252e and the sixth relevant fixation sequence 252f during the RE window. For example, if the proportion value calculated for the first nominee object 220 (picture frame) is determined to be higher than the proportion value calculated for the second nominee object 220 (lamp), the first nominee object 220 (picture frame) is then identified as the candidate object 220 for the concurrent pointing and gaze metric. However, if no pairs of relevant fixation sequences 252 are found to match/satisfy the concurrent pointing and gaze metric, then there is no candidate object 220 identified for the concurrent pointing and gaze metric.

In general, the pointing metric is satisfied by any single relevant fixation sequence 252 in the subset of relevant fixation sequences 252 that comprises pointing samples and specify an intersected object 220. Note that any relevant fixation sequence 252 in the subset of relevant fixation sequences 252 that comprises gaze samples is not related to the pointing metric and is not considered for the pointing metric.

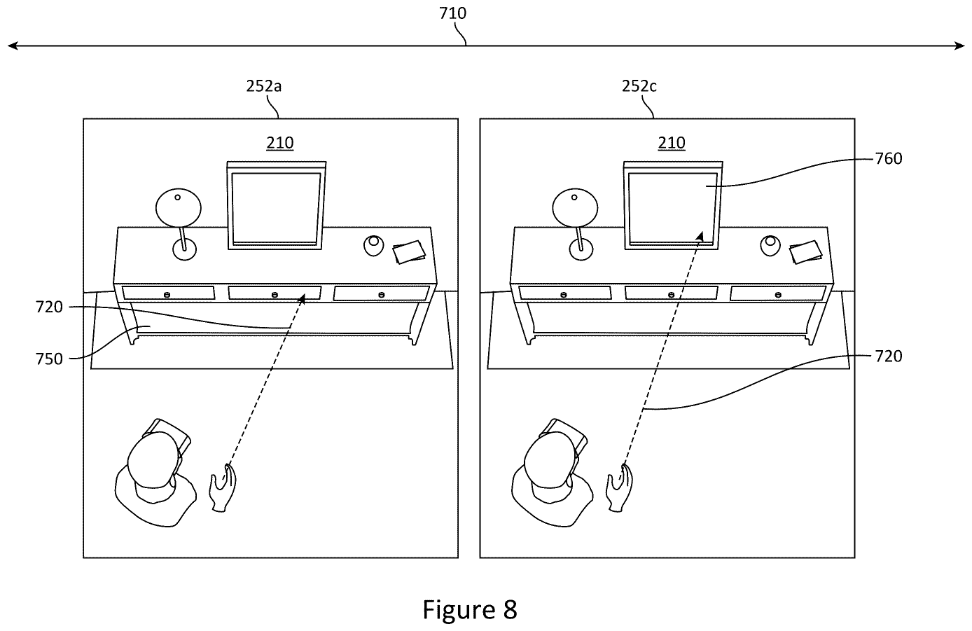

FIG. 8 is a conceptual illustration of relevant fixation sequences 252 that satisfy the pointing metric, according to various embodiments. FIG. 8 shows conceptual illustrations of a VR scene 210 corresponding to various relevant fixation sequences 252 (such as 252a and 252c) that each overlap an RE time window 710. Note that in the example of FIG. 8, only a portion of the subset of relevant fixation sequences 252 that overlap the RE time window 710 is shown, and the subset of relevant fixation sequences 252 can include other relevant fixation sequences 252 than those shown in FIG. 8.

As shown, the first relevant fixation sequence 252a comprises a sequence of pointing samples that each specify the first object 750 (cabinet) in a VR scene 210 that is intersected by the laser pointer ray 720, which satisfies the pointing metric. Also, the third relevant fixation sequence 252c comprises a sequence of pointing samples that each specify the second object 760 (picture frame) in the VR scene 210 that is intersected by the laser pointer ray 720, which also satisfies the pointing metric. Therefore, the first object 750 (cabinet) can be identified as a first nominee object 220 and the second object 760 (picture frame) can be identified as a second nominee object 220 for the pointing metric.

The single-user application 410 then calculates a proportion value for each nominee object 220 and selects the nominee object 220 having the highest proportion value as the candidate object 220 for the particular behavior metric. In some embodiments, the proportion value for a nominee object 220 of the pointing metric is determined by dividing the time duration of fixation for the nominee object 220 during the RE time window by the total duration of the RE time window, which is then multiplied by 100. Thus, the proportion value for a nominee object 220 indicates a percentage/proportion of fixation time of the nominee object 220 during the RE time window. For example, the time duration of fixation for the first nominee object 220 (cabinet) would comprise the time duration of the first relevant fixation sequence 252a during the RE time window, and the time duration of fixation for the second nominee object 220 (picture frame) would comprise the time duration of the third relevant fixation sequence 252c during the RE time window, which can be determined using the fixation tuples specified for the first relevant fixation sequence 252a and the third relevant fixation sequence 252c, respectively.

For example, if the proportion value calculated for the first nominee object 220 is determined to be higher than the proportion value calculated for the second nominee object 220, the first nominee object 220 is then identified as the candidate object 220 for the pointing metric. However, if no relevant fixation sequence 252 in the subset of relevant fixation sequences 252 is found to match/satisfy the pointing metric, then there is no candidate object 220 identified for the pointing metric.

In general, the gaze metric is satisfied by any single relevant fixation sequence 252 in the subset of relevant fixation sequences 252 that comprises gaze samples and specify an intersected object 220. Note that any relevant fixation sequence 252 in the subset of relevant fixation sequences 252 that comprises pointing samples is not related to the gaze metric and is not considered for the gaze metric.

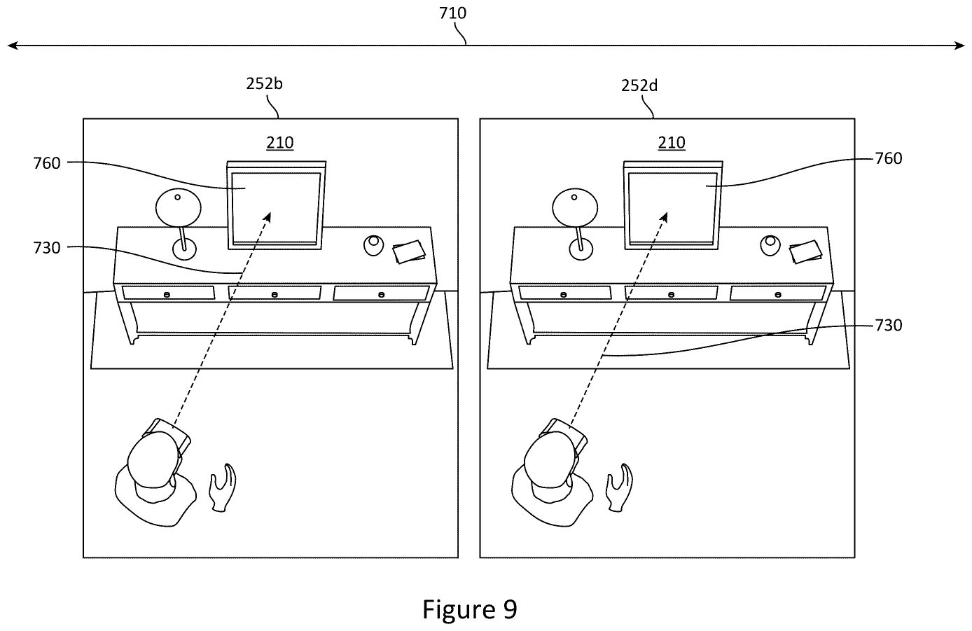

FIG. 9 is a conceptual illustration of relevant fixation sequences 252 that satisfy the gaze metric, according to various embodiments. FIG. 9 shows conceptual illustrations of a VR scene 210 corresponding to various relevant fixation sequences 252 (such as 252b and 252d) that each overlap an RE time window 710. Note that in the example of FIG. 9, only a portion of the subset of relevant fixation sequences 252 that overlap the RE time window 710 is shown, and the subset of relevant fixation sequences 252 can include other relevant fixation sequences 252 than those shown in FIG. 9.

As shown, the second relevant fixation sequence 252b comprises a sequence of gaze samples that each specify the second object 760 (picture frame) in a VR scene 210 that is intersected by the gaze ray 730, which satisfies the gaze metric. Also, the fourth relevant fixation sequence 252d comprises a sequence of gaze samples that each specify the second object 760 (picture frame) in the VR scene 210 that is intersected by the gaze ray 730, which also satisfies the gaze metric. Therefore, the second object 760 (picture frame) can be identified as a first nominee object 220 for the gaze metric.

Assuming the single-user application 410 identifies at least one other nominee object 220 for the gaze metric, the single-user application 410 then calculates a proportion value for each nominee object 220 and selects the nominee object 220 having the highest proportion value as the candidate object 220 for the particular behavior metric. In some embodiments, the proportion value for a nominee object 220 indicates a percentage/proportion of fixation time of the nominee object 220 during the RE time window.

Note that in the example of FIG. 9, the second object 760 (picture frame) is the object of fixation in two separate relevant fixation sequences 252b and 252d. As shown, the two relevant fixation sequences 252b and 252d are separated by a small time gap whereby the user may have quickly gazed at different objects 220 in the VR scene 210 and the corresponding gaze samples were determined to be noisy samples and filtered out. In this situation, the time duration of fixation for the second object 760 (picture frame) would be the sum of the time durations of the two separate relevant fixation sequences 252b and 252d. Thus, the time duration of fixation for the second object 760 (picture frame) would comprise the time duration of the second relevant fixation sequence 252b which is added to the time duration of the fourth relevant fixation sequence 252d during the RE time window, which can be determined using the fixation tuples specified for the second relevant fixation sequence 252b and the fourth relevant fixation sequence 252d, respectively. The above “summing” concept for the time duration of fixation applies to all behavior metrics where a same object of fixation is specified in separate relevant fixation sequences 252 having different time ranges within the RE time window.

For example, if the proportion value calculated for the first nominee object 220 is determined to be higher than the proportion value calculated for the second nominee object 220, the first nominee object 220 is then identified as the candidate object 220 for the gaze metric. However, if no relevant fixation sequence 252 in the subset of relevant fixation sequences 252 is found to match/satisfy the gaze metric, then there is no candidate object 220 identified for the gaze metric.

After a set of candidate objects 220 are identified for the first plurality of behavior metrics, the single-user application 410 then applies the first metric hierarchy to the set of candidate objects 220 to identify a final object 220 that is selected to correspond to and resolve the implicit RE. In some embodiments, the first metric hierarchy for a single-user VR session comprises a ranking order comprising a concurrent pointing and gaze metric at the top of the first metric hierarchy, then a pointing metric, and then a gaze metric at the bottom of the first metric hierarchy. In these embodiments, if there is a candidate object 220 identified for the concurrent pointing and gaze metric, then this candidate object 220 is selected as the final object 220 for the implicit RE. If not, it is then determined if there is a candidate object 220 identified for the pointing metric. If so, then this candidate object 220 is selected as the final object 220 for the implicit RE. If not, it is then determined if there is a candidate object 220 identified for the gaze metric. If so, then this candidate object 220 is selected as the final object 220 for the implicit RE. The single-user application 410 then associates the final object 220 with the corresponding implicit RE in the RE transcript 340 to generate the augmented transcript 430, such as by displaying the name of the final object 220 adjacent to the implicit RE in the augmented transcript 430. However, if no object is selected as the final object via the first metric hierarchy, then the implicit RE is left unresolved.

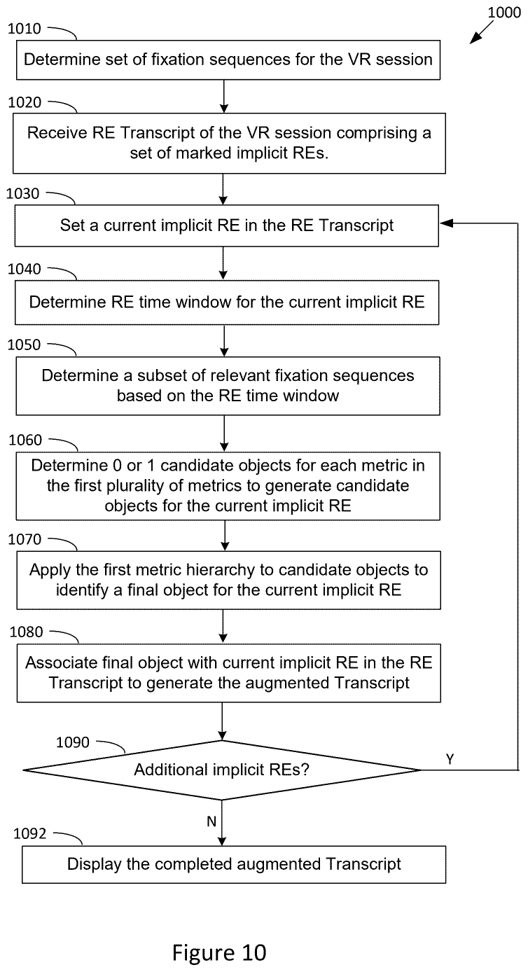

FIG. 10 sets forth a flow diagram of method steps for generating an augmented transcript for a single-user VR session, according to various embodiments. Although the method steps are described with reference to the systems of FIGS. 1-9, persons skilled in the art will understand that any system configured to implement the method steps, in any order, falls within the scope of the embodiments. In some embodiments, the method 1000 is executed by the single-user application 410 of the augmented transcript application 402 that executes on the AT system 400.

As shown, the method 1000 begins when the single-user application 410 determines (at step 1010) a set of fixation sequences 252 representing the single-user VR session. In some embodiments, the single-user application 410 receives the set of fixation sequences 252 from the VR system 200. In other embodiments, the single-user application 410 receives a set of VR samples 250 for the single-user VR session from the VR system 200 and determines the set of fixation sequences 252 based on the set of VR samples 250. In further embodiments, the single-user application 410 receives a set of VR samples 250 including the “alternative VR metadata” for the single-user VR session from the VR system 200, determines an intersected object associated with each VR sample, and then determines the set of fixation sequences 252 based on the VR samples 250 with associated intersected objects.

The single-user application 410 also receives (at step 1020) an RE transcript 340 of the single-user VR session from the ST system 300. The RE transcript 340 comprises a text transcript of the single-user VR session with each implicit RE being marked/indicated in the text transcript. The single-user application 410 then iteratively processes each implicit RE marked/indicated in the RE transcript 340 to resolve each implicit RE.

The single-user application 410 then sets (at step 1030) a next implicit RE that is marked in the RE transcript 340 as a current implicit RE to be processed. The single-user application 410 determines (at step 1040) an RE time window for the current implicit RE. The single-user application 410 determines (at step 1050) a subset of relevant fixation sequences 252 (subset of VR samples) based on the RE time window for the current implicit RE. The subset of relevant fixation sequences 252 are identified from the set of fixation sequences 252 for the VR session and thus comprises a sub-portion of the set of fixation sequences 252 for the VR session. In some embodiments, each relevant fixation sequence 252 overlaps in time (by any time amount) the RE time window of the current implicit RE. In other embodiments, a minimum threshold time amount of overlap is required with the RE time window.

The single-user application 410 then determines (at step 1060) 0 or 1 candidate objects 220 for each behavior metric in the first plurality of behavior metrics to generate a set of candidate objects 220 for the current implicit RE. The first plurality of behavior metrics for a single-user VR session comprises a concurrent pointing and gaze metric, a pointing metric, and a gaze metric. For each behavior metric, the single-user application 410 identifies 0 or more nominee objects 220. If only a first nominee object 220 is identified, then the first nominee object is identified as the candidate object 220 for the behavior metric. If two or more nominee objects 220 are identified, then a proportion value is calculated for each nominee object, and the nominee object having the highest proportion value is identified as the candidate object 220 for the behavior metric. If no nominee objects 220 are identified, then no object is identified as the candidate object 220 for the behavior metric.

The single-user application 410 then applies (at step 1070) the first metric hierarchy to the set of candidate objects 220 to identify a final object for the current implicit RE. In some embodiments, the single-user application 410 applies the first metric hierarchy by first determining if there is a candidate object 220 identified for the concurrent pointing and gaze metric. If so, then the single-user application 410 selects the candidate object 220 for the concurrent pointing and gaze metric as the final object 220 for the current implicit RE. If not, the single-user application 410 then determines if there is a candidate object 220 identified for the pointing metric. If so, then the single-user application 410 selects the candidate object 220 for the pointing metric as the final object 220 for the current implicit RE. If not, the single-user application 410 then determines if there is a candidate object 220 identified for the gaze metric. If so, then the single-user application 410 selects the candidate object 220 for the gaze metric as the final object 220 for the current implicit RE.

The single-user application 410 then associates (at step 1080) the selected final object 220 with the current implicit RE in the RE transcript 340 to generate the augmented transcript 430. For example, the single-user application 410 can display the name/identifier of the final object 220 adjacent to the current implicit RE in the augmented transcript 430. The single-user application 410 then determines (at step 1090) if any additional implicit REs need to be processed in the RE transcript 340. If so, the method 1000 iteratively returns to step 1030 whereby a next implicit RE marked in the RE transcript 340 is set as the current implicit RE to be processed. If not, the augmented transcript 430 is completed and the method 1000 displays (at step 1092) the augmented transcript 430 to the user via a user interface. As an optional step, the single-user application 410 can transmit (such as via the network 150) the augmented transcript 430 to the post-processing application 350 for further processing if needed. The method 1000 then ends.

### Section III: Two-User VR Session

In some embodiments, the VR session is executed/performed by two users, whereby the audio recording 240 and VR samples 250 of the VR session recording 230 (and the fixation sequences 252) relate to the two users. Therefore, the initial transcript application 310 generates an initial transcript 320, the RE transcript application 330 generates an RE transcript 340, and the two-user application 420 of the augmented transcript application 402 generates the augmented transcript 430 based on the two-user VR session.

FIG. 11 is a conceptual illustration of a set of two-user transcripts 1100 generated for a two-user VR session, according to various embodiments. As shown, the set of two-user transcripts 1100 includes an example initial transcript application 310, an example RE transcript 340, and an example augmented transcript 430. Each transcript 310, 340, and/or 430 can be generated and displayed to the users via a user interface displayed on a monitor, touchscreen, VR headset, or the like.

The initial transcript 320 comprises a text transcript conversion of the speech of the two users as captured in the audio recording 240 during the VR session. The initial transcript 320 can include timestamps or time ranges associated with each word or sentence in the initial transcript 320, the timestamps or time ranges being relative to the start of the VR session (start of the initial transcript 320). For each particular sentence, the initial transcript 320 also indicates the user that uttered/spoke the particular sentence during the VR session. As shown, the first user is identified as “P1” and the second user is identified as “P2” in the initial transcript 320. Additional features of the initial transcript 320 are discussed above in relation to FIG. 5, and are not discussed in detail here.

As shown, the RE transcript 340 comprises the initial transcript 320 but with implicit REs in the initial transcript 320 being visually marked/indicated in some manner. Each implicit RE is visually highlighted in some manner in the RE transcript 340. As shown in the example of FIG. 11, the implicit REs are underlined and bolded. Note that each implicit RE in the RE transcript 340 is associated with the particular user (P1 or P2) who uttered/spoke the implicit RE. Additional features of the RE transcript 340 are discussed above in relation to FIG. 5, and are not discussed in detail here.

As shown, the augmented transcript 430 comprises the RE transcript 340 but with the implicit REs being resolved in the augmented transcript 430. Each resolved implicit RE has a corresponding VR object 220, whereby the augmented transcript 430 visually indicates in some manner a correspondence/association between the resolved implicit RE and the corresponding VR object 220. In some embodiments, the name/identifier of the object 220 can be specified/inserted adjacent to the corresponding resolved implicit RE in the augmented transcript 430. In some embodiments, the behavior metric associated with the corresponding VR object 220 that was used to select the corresponding VR object 220 via the metric hierarchy can also be inserted/displayed in the augmented transcript 430. In addition, one or two user identifiers for the one or two users associated with the behavior metric can also be inserted/displayed in the augmented transcript 430. As shown in the example of FIG. 11, for each resolved implicit RE, the augmented transcript 430 specifies/inserts one or two user identifiers (“P1” and/or “P2”), the associated behavior metric, and the name of the corresponding VR object 220 adjacent to the resolved implicit RE in the augmented transcript 430 (such as “P1 and P2 concurrently pointing at kitchen island” being displayed adjacent to “This”). In further embodiments, the proportion values previously calculated for the corresponding VR object 220 and/or one or more nominee or candidate objects 220 can also be displayed adjacent to the name of the corresponding VR object 220 in the augmented transcript 430 (such as “P2 was pointing at the fridge 25% of the time and the sofa 75% of the time”).

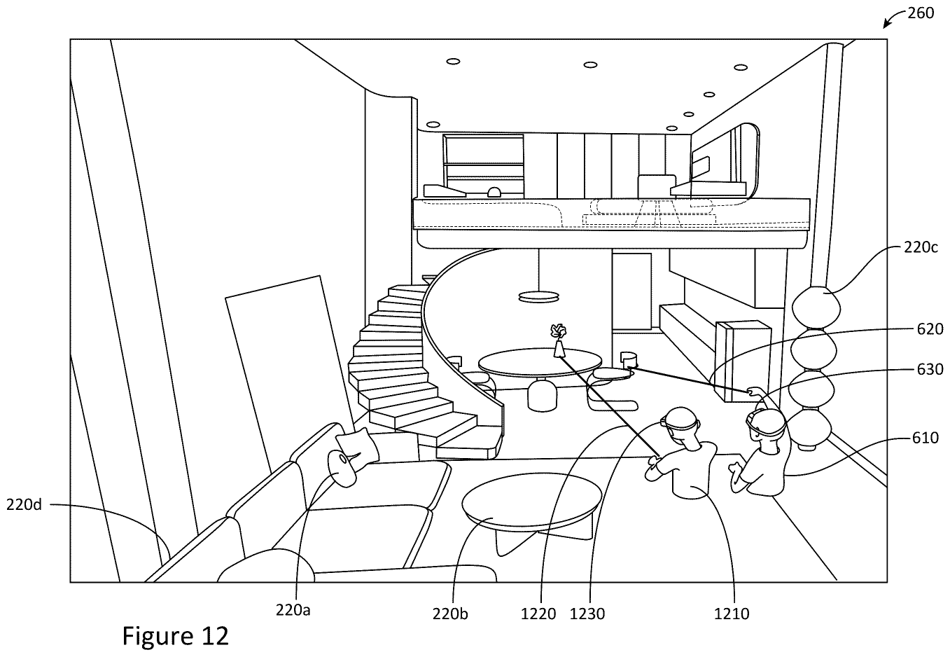

FIG. 12 is a conceptual illustration of a two-user VR session in a VR environment 260, according to various embodiments. In the VR system 200, the VR environment 260 is rendered by the VR engine 264 and displayed in each of two VR headsets 272 worn by each of the two users during the two-user VR session. As shown, the displayed VR environment 260 includes a 3D architectural design model of an apartment comprising a plurality of VR objects 220 (such as 220a, 220b, 220c, 220d, etc.). In other embodiments, the VR environment 260 includes any other type of 3D design model. The displayed VR environment 260 also includes a first-user avatar 610, a first-user laser pointer ray 620, a first-user VR headset avatar 630, a second-user avatar 1210, a second-user laser pointer ray 1220, a second-user VR headset avatar 1230. The base of the first-user laser pointer ray 620 can also be considered a first-user VR controller avatar and the base of the second-user laser pointer ray 1220 can also be considered a second-user VR controller avatar 1220.

During a two-user VR session, the first user wears a first-user VR headset 272a and controls a first-user VR controller 276a and the second user wears a second-user VR headset 272b and controls a second-user VR controller 276b. During the two-user VR session, each of the two users can individually/separately navigate the VR environment 260 and interact with the VR objects 220 via their respective VR controller 276, while providing speech/commentary via the microphone 274 of their respective VR headset 272. In particular, the first-user VR controller 276a controls the first-user laser pointer ray 620 which can be pointed to particular VR objects 220 to intersect the particular VR objects 220. The first user also controls the movement of the first-user VR headset 272a, which controls the movement of the first-user VR headset avatar 630 displayed in the VR environment. Thus, the first user controls a gaze ray that is projected (but not displayed) from the VR headset avatar 630 to particular VR objects 220 to intersect the particular VR objects 220. The second-user VR controller 276b controls the second-user laser pointer ray 1220 which can be pointed to particular VR objects 220 to intersect the particular VR objects 220 with the second-user laser pointer ray 1220. The second user also controls the movement of the second-user VR headset 272b, which controls the movement of the second-user VR headset avatar 1230 displayed in the VR environment. Thus, the second user controls a gaze ray that is projected (but not displayed) from the VR headset avatar 1230 to particular VR objects 220 to intersect the particular VR objects 220.

During the two-user VR session, the recording engine 140 generates an audio recording 240 of the speech/commentary provided by the two users and VR samples 250 (pointing and gaze samples) describing the non-verbal behaviors of the two users. The audio recording 240 can include audio speech from each user which can be separated into different audio tracks for each user. The recording engine 140 can generate and store VR samples 250 for each user separately. In this regard, the recording engine 140 can generate and store VR samples 250 associated with the first user based on the movements of the first-user VR headset 272a and the first-user VR controller 276a and can separately generate and store VR samples 250 associated with the second user based on the movements of the second-user VR headset 272b and the second-user VR controller 276b. Additional features of generating pointing samples and gaze samples are discussed above in relation to FIG. 6, and are not discussed in detail here.

After the two-user VR session is completed and an initial transcript 320 and RE transcript 340 is generated for the two-user VR session based on the audio recording 240, the set of fixation sequences 252 of the VR samples 250 is determined by the VR system 200 or the AT system 400. The set of fixation sequences 252 of the VR samples 250 can include a first set of fixation sequences 252 associated with the first user and a second set of fixation sequences 252 associated with the second user. For each implicit RE indicated in the RE transcript 340, the two-user application 420 of the augmented transcript application 402 determines an RE time window for the implicit RE and a subset of relevant fixation sequences 252 from the set of fixation sequences 252 based on the RE time window.

The two-user application 420 then identifies 0 or 1 candidate objects 220 for each of a second plurality of behavior metrics based on the subset of relevant fixation sequences 252. In some embodiments, the second plurality of behavior metrics for two users comprises a concurrent pointing metric, recurrent pointing metric, a single-user pointing metric, a concurrent gaze metric, recurrent gaze metric, and a single-user gaze metric. For each behavior metric, the two-user application 420 determines if one or more relevant fixation sequences 252 matches/satisfies the behavior metric, and if so, identifies nominee objects 220 from the matching fixation sequences 252. If two or more nominee objects 220 are identified from the subset of relevant fixation sequences 252, then the two-user application 420 calculates a proportion value for each nominee object 220 and selects the nominee object 220 having the highest proportion value as the candidate object 220 for the particular behavior metric. If no relevant fixation sequences 252 in the subset of relevant fixation sequences 252 are found to match/satisfy the behavior metric, then there is no candidate object 220 for the behavior metric.

In general, the concurrent pointing metric is satisfied when two conditions are met by a pair of relevant fixation sequences 252: 1) a first relevant fixation sequence 252 comprising pointing samples associated with the first user overlaps in time (by any time amount) with a second relevant fixation sequence 252 comprising pointing samples associated with the second user, and 2) the first relevant fixation sequence 252 and the second relevant fixation sequence 252 both specify the same intersected object 220. In other embodiments, a minimum threshold time amount of overlap is required. Note that both the above conditions need to be satisfied for the concurrent pointing metric to be satisfied by the first relevant fixation sequence 252 and the second relevant fixation sequence 252.

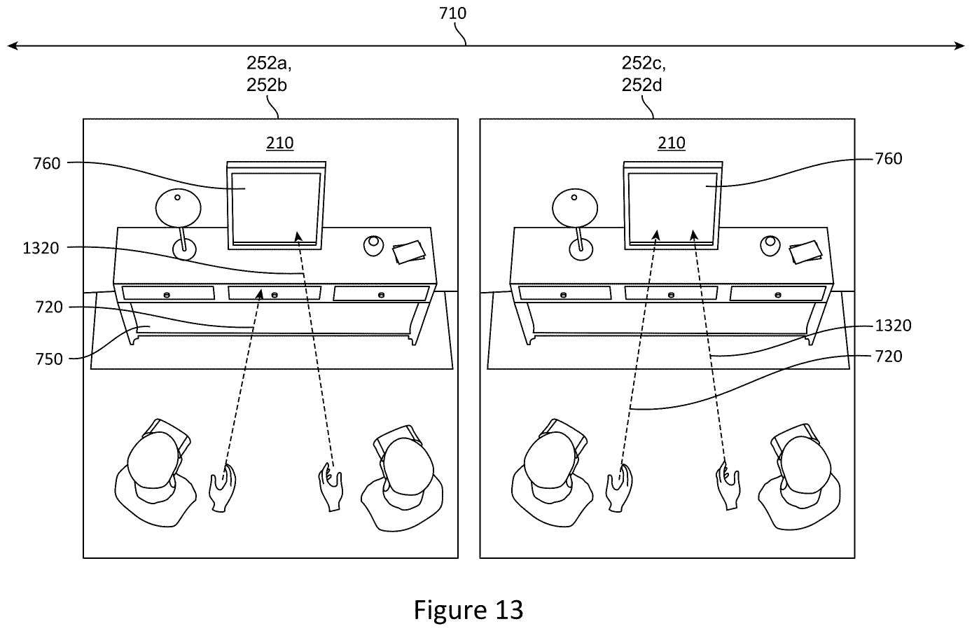

FIG. 13 is a conceptual illustration of a pair of relevant fixation sequences 252 that satisfy the concurrent pointing metric, according to various embodiments. FIG. 13 shows conceptual illustrations of a VR scene 210 corresponding to various relevant fixation sequences 252 (such as 252a, 252b, 252c, and 252d) that each overlap an RE time window 710. Note that in the example of FIG. 13, only a portion of the subset of relevant fixation sequences 252 that overlap the RE time window 710 is shown, and the subset of relevant fixation sequences 252 can include other relevant fixation sequences 252 than those shown in FIG. 13.

As shown, a first relevant fixation sequence 252a comprises a sequence of pointing samples that each specify a first object 750 (cabinet) in a VR scene 210 that is intersected by a first-user laser pointer ray 720 controlled by the first user. A second relevant fixation sequence 252b comprises a sequence of pointing samples that each specify a second object 760 (picture frame) in the VR scene 210 that is intersected by a second-user laser pointer ray 1320 controlled by the second user. The first relevant fixation sequence 252a comprising pointing samples associated with the first user overlaps in time with the second relevant fixation sequence 252b comprising pointing samples associated with the second user, which satisfies the first condition. However, the first relevant fixation sequence 252a and the second relevant fixation sequence 252b do not both specify the same intersected object 220, which does not satisfy the second condition. Thus, the first relevant fixation sequence 252a and the second relevant fixation sequence 252b do not satisfy the concurrent pointing metric.

As shown, a third relevant fixation sequence 252c comprises a sequence of pointing samples that each specify the second object 760 (picture frame) in the VR scene 210 that is intersected by the first-user laser pointer ray 720 controlled by the first user. A fourth relevant fixation sequence 252d comprises a sequence of pointing samples that each specify the second object 760 (picture frame) in the VR scene 210 that is intersected by the second-user laser pointer ray 1320 controlled by the second user. Thus, the third relevant fixation sequence 252c comprising pointing samples associated with the first user overlaps in time with the fourth relevant fixation sequence 252d comprising pointing samples associated with the second user (which satisfies the first condition), and the third relevant fixation sequence 252c and the fourth relevant fixation sequence 252d both specify the same intersected object 220 (the picture frame 760), which satisfies the second condition. Thus, the third relevant fixation sequence 252c and the fourth relevant fixation sequence 252d satisfy the concurrent pointing metric. Therefore, the same intersected object 220 (the picture frame 760) is identified as a first nominee object 220 for the concurrent pointing metric. If only one nominee object 220 is identified for the concurrent pointing metric based on the subset of relevant fixation sequences 252, then the one nominee object 220 comprises the candidate object 220 selected for the concurrent pointing metric.

However, if other pairs of relevant fixation sequence 252 within the subset of relevant fixation sequences 252 and the RE time window 710 satisfy the concurrent pointing metric, then one or more additional nominee objects 220 can be identified for the concurrent pointing metric. For example, a fifth relevant fixation sequence 252e (not shown) can comprise a sequence of pointing samples associated with the first user that each specify a third object (lamp) in the VR scene 210, which overlaps in time a sixth relevant fixation sequence 252f (not shown) comprising a sequence of pointing samples associated with the second user that each specify the same third object (lamp) in the VR scene 210. Thus, the fifth relevant fixation sequence 252e and the sixth relevant fixation sequence 252f also satisfy the concurrent pointing metric and the third object (lamp) is identified as a second nominee object 220 for the concurrent pointing metric.

If two or more nominee objects 220 are identified for a behavior metric, then the two-user application 420 calculates a proportion value for each nominee object 220 and selects the nominee object 220 having the highest proportion value as the candidate object 220 for the particular behavior metric. In some embodiments, the proportion value for a nominee object 220 of the concurrent pointing metric is determined by dividing the time duration of fixation overlap for the nominee object 220 during the RE time window 710 by the total duration of the RE time window 710, which is then multiplied by 100. For example, the time duration of fixation overlap for the first nominee object 220 (picture frame) would comprise the amount of time overlap between the third relevant fixation sequence 252c and the fourth relevant fixation sequence 252d during the RE time window 710, which can be determined using the fixation tuples specified for the third relevant fixation sequence 252c and the fourth relevant fixation sequence 252d. Likewise, the time duration of fixation overlap for the second nominee object 220 (lamp) would comprise the amount of time overlap between the fifth relevant fixation sequence 252e and the sixth relevant fixation sequence 252f during the RE window 710.

For example, if the proportion value calculated for the first nominee object 220 (picture frame) is determined to be higher than the proportion value calculated for the second nominee object 220 (lamp), the first nominee object 220 (picture frame) is then identified as the candidate object 220 for the concurrent pointing metric. However, if no pairs of relevant fixation sequences 252 are found to match/satisfy the concurrent pointing metric, then there is no candidate object 220 identified for the concurrent pointing metric.

In general, the recurrent pointing metric is satisfied when both users point to the same object 220 in the VR scene 210 within the duration of the RE time window 710 but do not point to the same object 220 simultaneously within the RE time window 710. In particular, the recurrent pointing metric is satisfied when two conditions are met by a pair of relevant fixation sequences 252: 1) a first relevant fixation sequence 252 comprising pointing samples associated with the first user does not overlap in time (by any time amount) with a second relevant fixation sequence 252 comprising pointing samples associated with the second user, and 2) the first relevant fixation sequence 252 and the second relevant fixation sequence 252 both specify the same intersected object 220. Note that both the above conditions need to be satisfied for the recurrent pointing metric to be satisfied by the first relevant fixation sequence 252 and the second relevant fixation sequence 252. Also note that if the first relevant fixation sequence 252 overlaps in time with the second relevant fixation sequence 252, then the concurrent pointing metric is satisfied and not the recurrent pointing metric.

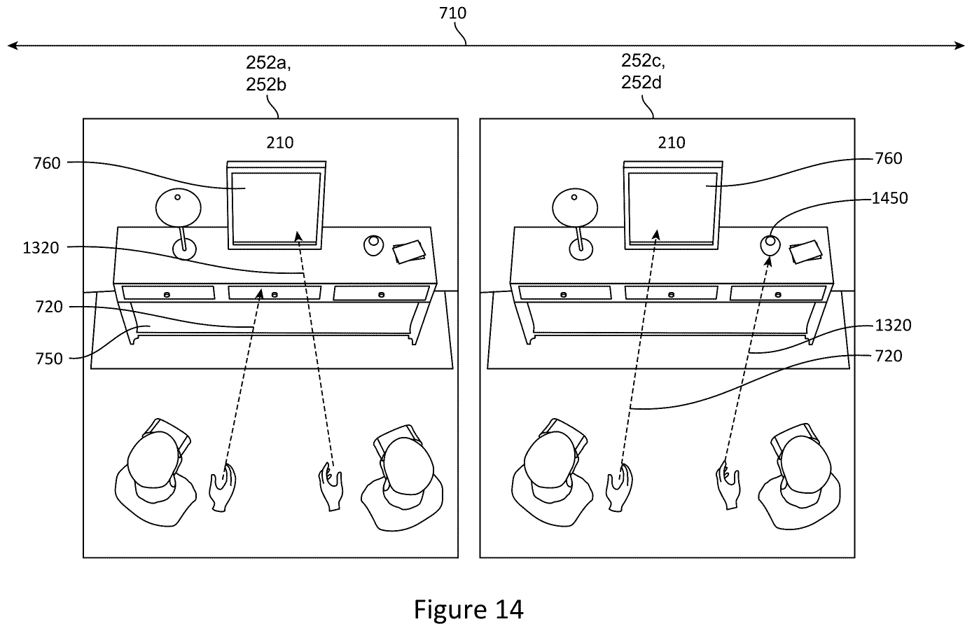

FIG. 14 is a conceptual illustration of a pair of relevant fixation sequences 252 that satisfy the recurrent pointing metric, according to various embodiments. FIG. 14 shows conceptual illustrations of a VR scene 210 corresponding to various relevant fixation sequences 252 (such as 252a, 252b, 252c, and 252d) that each overlap an RE time window 710. Note that in the example of FIG. 14, only a portion of the subset of relevant fixation sequences 252 that overlap the RE time window 710 is shown, and the subset of relevant fixation sequences 252 can include other relevant fixation sequences 252 than those shown in FIG. 14.

As shown, a first relevant fixation sequence 252a comprises a sequence of pointing samples that each specify a first object 750 (cabinet) in a VR scene 210 that is intersected by a first-user laser pointer ray 720 controlled by the first user. A second relevant fixation sequence 252b comprises a sequence of pointing samples that each specify a second object 760 (picture frame) in the VR scene 210 that is intersected by a second-user laser pointer ray 1320 controlled by the second user. A third relevant fixation sequence 252c comprises a sequence of pointing samples that each specify the second object 760 (picture frame) in the VR scene 210 that is intersected by the first-user laser pointer ray 720 controlled by the first user. A fourth relevant fixation sequence 252d comprises a sequence of pointing samples that each specify a third object 1450 (ornament) in the VR scene 210 that is intersected by the second-user laser pointer ray 1320 controlled by the second user.

Thus, the third relevant fixation sequence 252c comprising pointing samples associated with the first user does not overlap in time with the second relevant fixation sequence 252b comprising a sequence of pointing samples associated with the second user, which satisfies the first condition. Also, the third relevant fixation sequence 252c and the second relevant fixation sequence 252b both specify the same intersected object 220 (the picture frame 760), which satisfies the second condition. Thus, the third relevant fixation sequence 252c and the second relevant fixation sequence 252b satisfy the recurrent pointing metric. Therefore, the same intersected object 220 (the picture frame 760) is identified as a first nominee object 220 for the recurrent pointing metric. If only one nominee object 220 is identified for the recurrent pointing metric based on the subset of relevant fixation sequences 252, then the one nominee object 220 comprises the candidate object 220 selected for the recurrent pointing metric.

However, if two or more nominee objects 220 are identified for a behavior metric, then the two-user application 420 calculates a proportion value for each nominee object 220 and selects the nominee object 220 having the highest proportion value as the candidate object 220 for the particular behavior metric. In some embodiments, the proportion value for a nominee object 220 of the recurrent pointing metric is determined by dividing the total time duration of the pair of relevant fixation sequences 252 that satisfy the recurrent pointing metric by twice the total duration of the RE time window 710, which is then multiplied by 100. For example, the total time duration of the pair of relevant fixation sequences 252 that satisfy the recurrent pointing metric would comprise the total of the time duration of the third relevant fixation sequence 252c and the time duration of the second relevant fixation sequence 252b during the RE time window 710, which can be determined using the fixation tuples specified for the third relevant fixation sequence 252c and the second relevant fixation sequence 252b. The nominee object 220 having the highest proportion value is then identified as the candidate object 220 for the recurrent pointing metric. However, if no pairs of relevant fixation sequences 252 are found to match/satisfy the recurrent pointing metric, then there is no candidate object 220 identified for the recurrent pointing metric.

In general, the single-user pointing metric focuses on the pointing behavior of only the user that uttered/spoke the current implicit RE being processed in the RE transcript 340, the user being referred to as the speaking user. Here, the pointing behavior of the other non-speaking user is not considered for the single-user pointing metric. In particular, the single-user pointing metric is satisfied by any single relevant fixation sequence 252 in the subset of relevant fixation sequences 252 that comprises pointing samples associated with the speaking user and specify an intersected object 220. Note that any relevant fixation sequence 252 in the subset of relevant fixation sequences 252 that comprises gaze samples associated with either users is not related to the single-user pointing metric and is not considered for the single-user pointing metric.

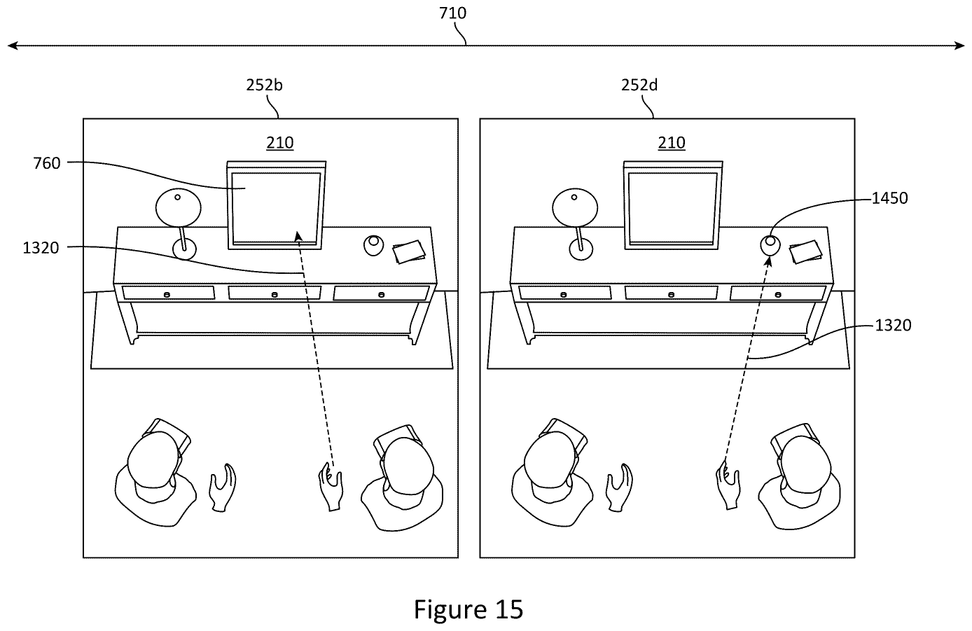

FIG. 15 is a conceptual illustration of relevant fixation sequences 252 that satisfy the single-user pointing metric, according to various embodiments. FIG. 15 shows conceptual illustrations of a VR scene 210 corresponding to various relevant fixation sequences 252 (such as 252b and 252d) that each overlap an RE time window 710. Note that in the example of FIG. 15, only a portion of the subset of relevant fixation sequences 252 that overlap the RE time window 710 is shown, and the subset of relevant fixation sequences 252 can include other relevant fixation sequences 252 than those shown in FIG. 15.

In the example of FIG. 15, the second user is the speaking user that uttered/spoke the current implicit RE being processed and the first user is the non-speaking user. Thus, only the relevant fixation sequences 252 (such as 252b and 252d) comprising pointing samples associated with the second user are considered. As shown, the second relevant fixation sequence 252b comprises a sequence of pointing samples that each specify the second object 760 (picture frame) in the VR scene 210 that is intersected by the second-user laser pointer ray 1320 controlled by the second user, which satisfies the single-user pointing metric. The fourth relevant fixation sequence 252d comprises a sequence of pointing samples that each specify the third object 1450 (ornament) in the VR scene 210 that is intersected by the second-user laser pointer ray 1320 controlled by the second user, which also satisfies the single-user pointing metric. Therefore, the second object 760 (picture frame) can be identified as a first nominee object 220 and the third object 1450 (ornament) can be identified as a second nominee object 220 for the single-user pointing metric.

The two-user application 420 then calculates a proportion value for each nominee object 220 and selects the nominee object 220 having the highest proportion value as the candidate object 220 for the particular behavior metric. In some embodiments, the proportion value for a nominee object 220 of the single-user pointing metric is determined by dividing the time duration of fixation for the nominee object 220 during the RE time window by the total duration of the RE time window, which is then multiplied by 100. For example, the time duration of fixation for the first nominee object 220 (picture frame) would comprise the time duration of the second relevant fixation sequence 252b during the RE time window, and the time duration of fixation for the second nominee object 220 (ornament) would comprise the time duration of the fourth relevant fixation sequence 252d during the RE time window, which can be determined using the fixation tuples specified for the second relevant fixation sequence 252b and the fourth relevant fixation sequence 252d, respectively.

For example, if the proportion value calculated for the first nominee object 220 is determined to be higher than the proportion value calculated for the second nominee object 220, the first nominee object 220 is then identified as the candidate object 220 for the single-user pointing metric. However, if no relevant fixation sequence 252 in the subset of relevant fixation sequences 252 is found to match/satisfy the single-user pointing metric, then there is no candidate object 220 identified for the single-user pointing metric.

In general, the concurrent gaze metric is satisfied when two conditions are met by a pair of relevant fixation sequences 252: 1) a first relevant fixation sequence 252 comprising gaze samples associated with the first user overlaps in time (by any time amount) with a second relevant fixation sequence 252 comprising gaze samples associated with the second user, and 2) the first relevant fixation sequence 252 and the second relevant fixation sequence 252 both specify the same intersected object 220. In other embodiments, a minimum threshold time amount of overlap is required. Note that both the above conditions need to be satisfied for the concurrent gaze metric to be satisfied by the first relevant fixation sequence 252 and the second relevant fixation sequence 252.

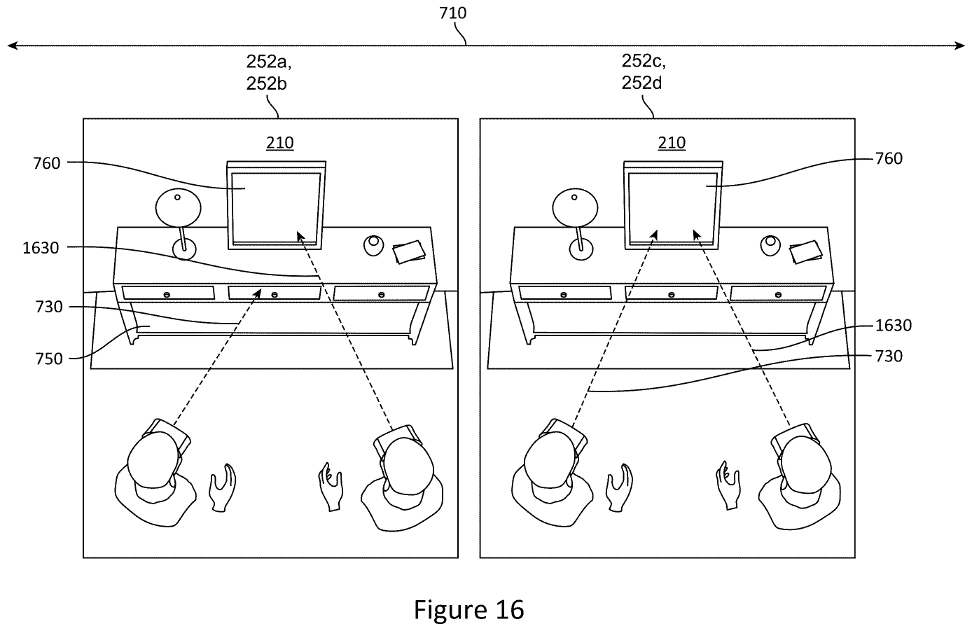

FIG. 16 is a conceptual illustration of a pair of relevant fixation sequences 252 that satisfy the concurrent gaze metric, according to various embodiments. FIG. 16 shows conceptual illustrations of a VR scene 210 corresponding to various relevant fixation sequences 252 (such as 252a, 252b, 252c, and 252d) that each overlap an RE time window 710. Note that in the example of FIG. 16, only a portion of the subset of relevant fixation sequences 252 that overlap the RE time window 710 is shown, and the subset of relevant fixation sequences 252 can include other relevant fixation sequences 252 than those shown in FIG. 16.

As shown, a first relevant fixation sequence 252a comprises a sequence of gaze samples that each specify a first object 750 (cabinet) in a VR scene 210 that is intersected by a first-user gaze ray 730 controlled by the first user. A second relevant fixation sequence 252b comprises a sequence of gaze samples that each specify a second object 760 (picture frame) in the VR scene 210 that is intersected by a second-user gaze ray 1630 controlled by the second user. The first relevant fixation sequence 252a comprising gaze samples associated with the first user overlaps in time with the second relevant fixation sequence 252b comprising gaze samples associated with the second user, which satisfies the first condition. However, the first relevant fixation sequence 252a and the second relevant fixation sequence 252b do not both specify the same intersected object 220, which does not satisfy the second condition. Thus, the first relevant fixation sequence 252a and the second relevant fixation sequence 252b do not satisfy the concurrent gaze metric.

As shown, a third relevant fixation sequence 252c comprises a sequence of gaze samples that each specify the second object 760 (picture frame) in the VR scene 210 that is intersected by the first-user gaze ray 730 controlled by the first user. A fourth relevant fixation sequence 252d comprises a sequence of gaze samples that each specify the second object 760 (picture frame) in the VR scene 210 that is intersected by the second-user gaze ray 1630 controlled by the second user. Thus, the third relevant fixation sequence 252c comprising gaze samples associated with the first user overlaps in time with the fourth relevant fixation sequence 252d comprising gaze samples associated with the second user (which satisfies the first condition), and the third relevant fixation sequence 252c and the fourth relevant fixation sequence 252d both specify the same intersected object 220 (the picture frame 760), which satisfies the second condition. Thus, the third relevant fixation sequence 252c and the fourth relevant fixation sequence 252d satisfy the concurrent gaze metric. Therefore, the same intersected object 220 (the picture frame 760) is identified as a first nominee object 220 for the concurrent gaze metric. If only one nominee object 220 is identified for the concurrent gaze metric based on the subset of relevant fixation sequences 252, then the one nominee object 220 comprises the candidate object 220 selected for the concurrent gaze metric.

However, if two or more nominee objects 220 are identified for a behavior metric, then the two-user application 420 calculates a proportion value for each nominee object 220 and selects the nominee object 220 having the highest proportion value as the candidate object 220 for the particular behavior metric. In some embodiments, the proportion value for a nominee object 220 of the concurrent gaze metric is determined by dividing the time duration of fixation overlap for the nominee object 220 during the RE time window 710 by the total duration of the RE time window 710, which is then multiplied by 100. For example, the time duration of fixation overlap for the first nominee object 220 (picture frame) would comprise the amount of time overlap between the third relevant fixation sequence 252c and the fourth relevant fixation sequence 252d during the RE time window 710, which can be determined using the fixation tuples specified for the third relevant fixation sequence 252c and the fourth relevant fixation sequence 252d.

For example, if the proportion value calculated for the first nominee object 220 (picture frame) is determined to be higher than the proportion value calculated for the second nominee object 220 (lamp), the first nominee object 220 (picture frame) is then identified as the candidate object 220 for the concurrent gaze metric. However, if no pairs of relevant fixation sequences 252 are found to match/satisfy the concurrent gaze metric, then there is no candidate object 220 identified for the concurrent gaze metric.

In general, the recurrent gaze metric is satisfied when both users gaze at the same object 220 in the VR scene 210 within the duration of the RE time window 710 but do not gaze at the same object 220 simultaneously within the RE time window 710. In particular, the recurrent gaze metric is satisfied when two conditions are met by a pair of relevant fixation sequences 252: 1) a first relevant fixation sequence 252 comprising gaze samples associated with the first user does not overlap in time (by any time amount) with a second relevant fixation sequence 252 comprising gaze samples associated with the second user, and 2) the first relevant fixation sequence 252 and the second relevant fixation sequence 252 both specify the same intersected object 220. Note that both the above conditions need to be satisfied for the recurrent gaze metric to be satisfied by the first relevant fixation sequence 252 and the second relevant fixation sequence 252. Also note that if the first relevant fixation sequence 252 overlaps in time with the second relevant fixation sequence 252, then the concurrent gaze metric is satisfied and not the recurrent gaze metric.

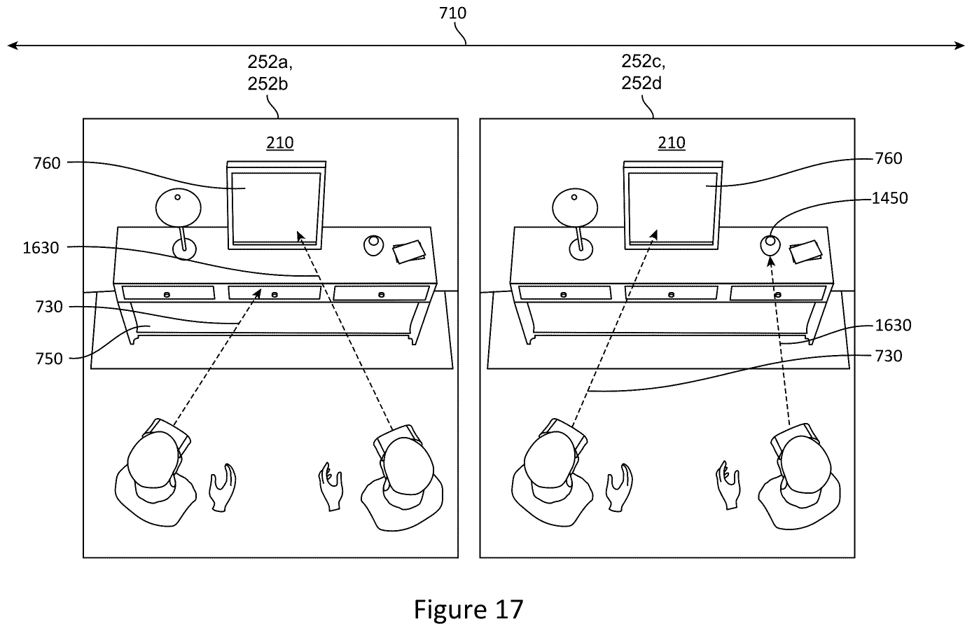

FIG. 17 is a conceptual illustration of a pair of relevant fixation sequences 252 that satisfy the recurrent gaze metric, according to various embodiments. FIG. 17 shows conceptual illustrations of a VR scene 210 corresponding to various relevant fixation sequences 252 (such as 252a, 252b, 252c, and 252d) that each overlap an RE time window 710. Note that in the example of FIG. 17, only a portion of the subset of relevant fixation sequences 252 that overlap the RE time window 710 is shown, and the subset of relevant fixation sequences 252 can include other relevant fixation sequences 252 than those shown in FIG. 17.

As shown, a first relevant fixation sequence 252a comprises a sequence of gaze samples that each specify a first object 750 (cabinet) in a VR scene 210 that is intersected by a first-user gaze ray 730 controlled by the first user. A second relevant fixation sequence 252b comprises a sequence of gaze samples that each specify a second object 760 (picture frame) in the VR scene 210 that is intersected by a second-user gaze ray 1630 controlled by the second user. A third relevant fixation sequence 252c comprises a sequence of gaze samples that each specify the second object 760 (picture frame) in the VR scene 210 that is intersected by the first-user gaze ray 730 controlled by the first user. A fourth relevant fixation sequence 252d comprises a sequence of gaze samples that each specify a third object 1450 (ornament) in the VR scene 210 that is intersected by the second-user gaze ray 1630 controlled by the second user.

Thus, the third relevant fixation sequence 252c comprising gaze samples associated with the first user does not overlap in time with the second relevant fixation sequence 252b comprising a sequence of gaze samples associated with the second user, which satisfies the first condition. Also, the third relevant fixation sequence 252c and the second relevant fixation sequence 252b both specify the same intersected object 220 (the picture frame 760), which satisfies the second condition. Thus, the third relevant fixation sequence 252c and the second relevant fixation sequence 252b satisfy the recurrent gaze metric. Therefore, the same intersected object 220 (the picture frame 760) is identified as a first nominee object 220 for the recurrent gaze metric. If only one nominee object 220 is identified for the recurrent gaze metric based on the subset of relevant fixation sequences 252, then the one nominee object 220 comprises the candidate object 220 selected for the recurrent gaze metric.

However, if two or more nominee objects 220 are identified for a behavior metric, then the two-user application 420 calculates a proportion value for each nominee object 220 and selects the nominee object 220 having the highest proportion value as the candidate object 220 for the particular behavior metric. In some embodiments, the proportion value for a nominee object 220 of the recurrent gaze metric is determined by dividing the total time duration of the pair of relevant fixation sequences 252 that satisfy the recurrent gaze metric by twice the total duration of the RE time window 710, which is then multiplied by 100. For example, the total time duration of the pair of relevant fixation sequences 252 that satisfy the recurrent gaze metric would comprise the total of the time duration of the third relevant fixation sequence 252c and the time duration of the second relevant fixation sequence 252b during the RE time window 710, which can be determined using the fixation tuples specified for the third relevant fixation sequence 252c and the second relevant fixation sequence 252b. The nominee object 220 having the highest proportion value is then identified as the candidate object 220 for the recurrent gaze metric. However, if no pairs of relevant fixation sequences 252 are found to match/satisfy the recurrent gaze metric, then there is no candidate object 220 identified for the recurrent gaze metric.

In general, the single-user gaze metric focuses on the gaze behavior of only the user that uttered/spoke the current implicit RE being processed in the RE transcript 340, the user being referred to as the speaking user. Here, the gaze behavior of the other non-speaking user is not considered for the single-user gaze metric. In particular, the single-user gaze metric is satisfied by any single relevant fixation sequence 252 in the subset of relevant fixation sequences 252 that comprises gaze samples associated with the speaking user and specify an intersected object 220. Note that any relevant fixation sequence 252 in the subset of relevant fixation sequences 252 that comprises pointing samples associated with either users is not related to the single-user gaze metric and is not considered for the single-user gaze metric.

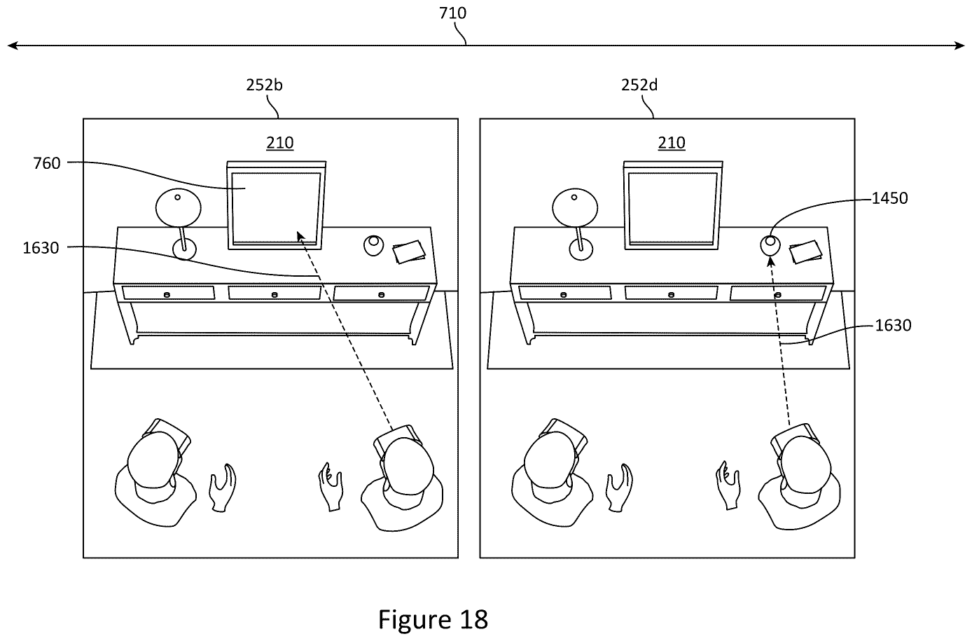

FIG. 18 is a conceptual illustration of relevant fixation sequences 252 that satisfy the single-user gaze metric, according to various embodiments. FIG. 18 shows conceptual illustrations of a VR scene 210 corresponding to various relevant fixation sequences 252 (such as 252b and 252d) that each overlap an RE time window 710. Note that in the example of FIG. 18, only a portion of the subset of relevant fixation sequences 252 that overlap the RE time window 710 is shown, and the subset of relevant fixation sequences 252 can include other relevant fixation sequences 252 than those shown in FIG. 18.

In the example of FIG. 18, the second user is the speaking user that uttered/spoke the current implicit RE being processed and the first user is the non-speaking user. Thus, only the relevant fixation sequences 252 (such as 252b and 252d) comprising gaze samples associated with the second user are considered. As shown, the second relevant fixation sequence 252b comprises a sequence of gaze samples that each specify the second object 760 (picture frame) in the VR scene 210 that is intersected by the second-user gaze ray 1630 controlled by the second user, which satisfies the single-user gaze metric. The fourth relevant fixation sequence 252d comprises a sequence of gaze samples that each specify the third object 1450 (ornament) in the VR scene 210 that is intersected by the second-user gaze ray 1630 controlled by the second user, which also satisfies the single-user gaze metric. Therefore, the second object 760 (picture frame) can be identified as a first nominee object 220 and the third object 1450 (ornament) can be identified as a second nominee object 220 for the single-user gaze metric.

The two-user application 420 then calculates a proportion value for each nominee object 220 and selects the nominee object 220 having the highest proportion value as the candidate object 220 for the particular behavior metric. In some embodiments, the proportion value for a nominee object 220 of the single-user gaze metric is determined by dividing the time duration of fixation for the nominee object 220 during the RE time window by the total duration of the RE time window, which is then multiplied by 100. For example, the time duration of fixation for the first nominee object 220 (picture frame) would comprise the time duration of the second relevant fixation sequence 252b during the RE time window, and the time duration of fixation for the second nominee object 220 (ornament) would comprise the time duration of the fourth relevant fixation sequence 252d during the RE time window, which can be determined using the fixation tuples specified for the second relevant fixation sequence 252b and the fourth relevant fixation sequence 252d, respectively.

For example, if the proportion value calculated for the first nominee object 220 is determined to be higher than the proportion value calculated for the second nominee object 220, the first nominee object 220 is then identified as the candidate object 220 for the single-user gaze metric. However, if no relevant fixation sequence 252 in the subset of relevant fixation sequences 252 is found to match/satisfy the single-user gaze metric, then there is no candidate object 220 identified for the single-user gaze metric.

After a set of candidate objects 220 are identified for the second plurality of behavior metrics, the two-user application 420 then applies the second metric hierarchy to the set of candidate objects 220 to identify a final object 220 that is selected to correspond to and resolve the implicit RE. In some embodiments, the second metric hierarchy for a two-user VR session comprises a concurrent pointing metric at the top of the second metric hierarchy, then a recurrent pointing metric, then a single-user pointing metric, then a concurrent gaze metric, then a recurrent gaze metric, and then a single-user gaze metric at the bottom of the second metric hierarchy. The two-user application 420 then associates the final object 220 with the corresponding implicit RE in the RE transcript 340 to generate the augmented transcript 430, such as by displaying the name of the final object 220 adjacent to the implicit RE in the augmented transcript 430. However, if no object is selected as the final object via the second metric hierarchy, then the implicit RE is left unresolved.

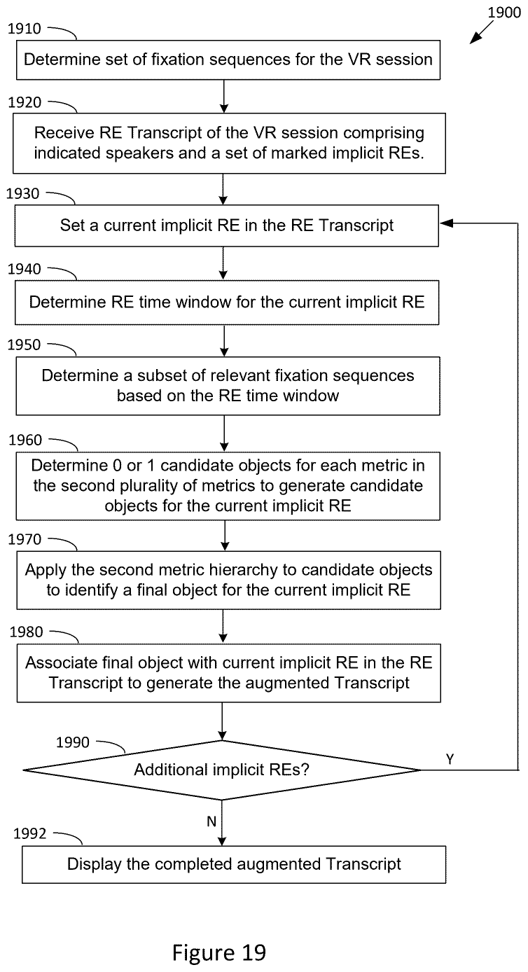

FIG. 19 sets forth a flow diagram of method steps for generating an augmented transcript for a two-user VR session, according to various embodiments. Although the method steps are described with reference to the systems of FIGS. 1-9 and 11-18, persons skilled in the art will understand that any system configured to implement the method steps, in any order, falls within the scope of the embodiments. In some embodiments, the method 1900 is executed by the two-user application 420 of the augmented transcript application 402 that executes on the AT system 400.

As shown, the method 1900 begins when the two-user application 420 determines (at step 1910) a set of fixation sequences 252 representing the two-user VR session. Each fixation sequence 252 comprises a sequence of VR samples associated with either a first user or a second user. In addition, each fixation sequence 252 comprises a sequence of either pointing samples or gaze samples. In some embodiments, the two-user application 420 receives (such as via the network 150) the set of fixation sequences 252 from the VR system 200. In other embodiments, the two-user application 420 receives (such as via the network 150) a set of VR samples 250 for the two-user VR session from the VR system 200 and determines the set of fixation sequences 252 based on the set of VR samples 250. In further embodiments, the two-user application 420 receives a set of VR samples 250 including the “alternative VR metadata” for the two-user VR session from the VR system 200, determines an intersected object associated with each VR sample, and then determines the set of fixation sequences 252 based on the VR samples 250 with associated intersected objects.

The two-user application 420 also receives (at step 1920) an RE transcript 340 of the two-user VR session from the ST system 300. The RE transcript 340 comprises a text transcript of the two-user VR session, whereby the user that uttered/spoke each sentence is indicated in the text transcript (i.e., either the first user “P1” or the second user “P2”). In addition, the RE transcript 340 comprises a text transcript of the two-user VR session with each implicit RE being marked/indicated in the text transcript. The two-user application 420 then iteratively processes each implicit RE marked/indicated in the RE transcript 340 to resolve each implicit RE.

The two-user application 420 then sets (at step 1930) a next implicit RE that is marked in the RE transcript 340 as a current implicit RE to be processed. The two-user application 420 determines (at step 1940) an RE time window for the current implicit RE. The two-user application 420 determines (at step 1950) a subset of relevant fixation sequences 252 based on the RE time window for the current implicit RE. The subset of relevant fixation sequences 252 are identified from the set of fixation sequences 252 for the two-user VR session and thus comprises a sub-portion of the set of fixation sequences 252 for the two-user VR session. In some embodiments, each relevant fixation sequence 252 overlaps in time (by any amount of time) the RE time window of the current implicit RE. In other embodiments, a minimum threshold time amount of overlap is required with the RE time window.

The two-user application 420 then determines (at step 1960) 0 or 1 candidate objects 220 for each behavior metric in the second plurality of behavior metrics to generate a set of candidate objects 220 for the current implicit RE. The second plurality of behavior metrics for a two-user VR session comprises a concurrent pointing metric, recurrent pointing metric, a single-user pointing metric, a concurrent gaze metric, recurrent gaze metric, and a single-user gaze metric. For each behavior metric, the two-user application 420 identifies 0 or more nominee objects 220. If only a first nominee object 220 is identified, then the first nominee object is identified as the candidate object 220 for the behavior metric. If two or more nominee objects 220 are identified, then a proportion value is calculated for each nominee object, and the nominee object having the highest proportion value is identified as the candidate object 220 for the behavior metric. If no nominee objects 220 are identified, then no object is identified as the candidate object 220 for the behavior metric.

The two-user application 420 then applies (at step 1970) the second metric hierarchy to the set of candidate objects 220 to identify a final object for the current implicit RE. In some embodiments, the two-user application 420 applies the second metric hierarchy by first determining if there is a candidate object 220 identified for the concurrent pointing metric. If so, then the two-user application 420 selects the candidate object 220 for the concurrent pointing metric as the final object 220 for the current implicit RE. If not, the two-user application 420 then determines if there is a candidate object 220 identified for the recurrent pointing metric. If so, then the two-user application 420 selects the candidate object 220 for the recurrent pointing metric as the final object 220 for the current implicit RE. If not, the two-user application 420 then determines if there is a candidate object 220 identified for the single-user pointing metric. If so, then the two-user application 420 selects the candidate object 220 for the single-user pointing metric as the final object 220 for the current implicit RE. If not, the two-user application 420 then determines if there is a candidate object 220 identified for the concurrent gaze metric. If so, then the two-user application 420 selects the candidate object 220 for the concurrent gaze metric as the final object 220 for the current implicit RE. If not, the two-user application 420 then determines if there is a candidate object 220 identified for the recurrent gaze metric. If so, then the two-user application 420 selects the candidate object 220 for the recurrent gaze metric as the final object 220 for the current implicit RE. If not, the two-user application 420 then determines if there is a candidate object 220 identified for the single-user gaze metric. If so, then the two-user application 420 selects the candidate object 220 for the single-user gaze metric as the final object 220 for the current implicit RE.

The two-user application 420 then associates (at step 1980) the selected final object 220 with the current implicit RE in the RE transcript 340 to generate the augmented transcript 430. For example, the two-user application 420 can display the name/identifier of the final object 220 adjacent to the current implicit RE in the augmented transcript 430. The two-user application 420 then determines (at step 1990) if any additional implicit REs need to be processed in the RE transcript 340. If so, the method 1900 iteratively returns to step 1930 whereby a next implicit RE marked in the RE transcript 340 is set as the current implicit RE to be processed. If not, the augmented transcript 430 is completed and the method 1900 displays (at step 1992) the augmented transcript 430 to the users via a user interface. As an optional step, the two-user application 420 can transmit (such as via the network 150) the augmented transcript 430 to the post-processing application 350 for further processing if needed. The method 1900 then ends.

In sum, a VR system generates a VR session recording of a VR session performed by one or two users, the VR session recording comprising an audio recording and a set of VR samples. The set of VR samples comprises samples of VR metadata captured during the entirety of the VR session, including pointing samples and gaze samples of the one or two users. The pointing samples for a particular user are associated with a laser pointer ray of a VR controller that is controlled by the particular user. A pointing sample can include a name of an object intersected by the laser pointer ray and a timestamp for when the pointing sample was collected during the VR session. The gaze samples for a particular user are associated with a gaze ray of a VR headset worn by the particular user. A gaze sample can include a name of an object intersected by the gaze ray and a timestamp for when the pointing sample was collected during the VR session.

An initial transcript application generates an initial transcript based on the audio recording, the initial transcript comprising a text transcript of the speech captured in the audio recording. An RE transcript application generates an RE transcript based on the initial transcript, the RE transcript marking/indicating each implicit referring expression (RE) contained in the initial transcript. An augmented transcript application then generates an augmented transcript based on the RE transcript and the set of VR samples. The RE transcript indicates a plurality of implicit REs that are to be resolved. The augmented transcript application resolves each implicit RE by identifying a particular VR object of the VR environment that corresponds to the implicit RE.

The augmented transcript application can resolve a particular implicit RE by determining a time window associated with the particular implicit RE and identifying a subset of relevant VR samples, from the set of VR samples, based on the time window. The subset of relevant VR samples 250 can be used to identify a set of candidate objects for a set of behavior metrics, from which a final object can be identified by applying a behavior metric hierarchy to the set of candidate objects. The final object is selected as corresponding to and resolving the implicit RE. The augmented transcript application then associates the selected final objects with the corresponding implicit REs in the RE transcript to generate the augmented transcript.

At least one technical advantage of the disclosed techniques relative to the prior art is that the disclosed techniques consider non-verbal behaviors of a single user during a single-user VR session to resolve referring expressions in a text transcript of the VR session. The non-verbal behaviors can include a pointing behavior and/or gaze behavior of the single user in relation to various VR objects in the VR environment during the VR session. In this manner, the non-verbal behaviors of the single user during the VR session can be leveraged to more accurately resolve referring expressions in a text transcript relative to prior approaches that did not consider non-verbal behaviors of the user and considered only verbal behaviors of the user when resolving referring expressions in the text transcript. These technical advantages provide one or more technological advancements over prior art approaches.

At least one technical advantage of the disclosed techniques relative to the prior art is that the disclosed techniques consider concurrent or recurrent non-verbal behaviors of a first user and a second user during a two-user VR session to resolve referring expressions in a text transcript of the VR session. The non-verbal behaviors can include a concurrent or recurrent pointing behavior of the first user and the second user and/or a concurrent or recurrent gaze behavior of the first user and the second user in relation to various VR objects in the VR environment during the VR session. In this manner, the non-verbal behaviors of the first user and the second user during the VR session can be leveraged to more accurately resolve referring expressions in a text transcript relative to prior approaches that did not consider non-verbal behaviors of the users and considered only verbal behaviors of the users when resolving referring expressions in the text transcript. These technical advantages provide one or more technological advancements over prior art approaches.

1. In some embodiments, a computer-implemented method for generating an augmented transcript of a two-user virtual reality (VR) session comprises identifying a first referring expression in a text transcript of the VR session performed by a first user and a second user in a VR environment, analyzing at least one concurrent or recurrent non-verbal behavior of the first user and the second user during the VR session to determine a first virtual object in the VR environment associated with the first referring expression, and specifying a first name of the first virtual object in the text transcript to generate the augmented transcript.

2. The computer-implemented method of clause 1, wherein the at least one concurrent or recurrent non-verbal behavior includes a concurrent or recurrent pointing behavior of the first user and the second user.

3. The computer-implemented method of clauses 1 or 2, wherein the at least one concurrent or recurrent non-verbal behavior includes a concurrent or recurrent gaze behavior of the first user and the second user.

4. The computer-implemented method of any of clauses 1-3, wherein analyzing the at least one concurrent or recurrent non-verbal behavior of the first user and the second user comprises determining a first time window associated with the first referring expression, and determining that the first user and the second user concurrently pointed at the first virtual object in the VR environment within the first time window.

5. The computer-implemented method of any of clauses 1-4, wherein analyzing the at least one concurrent or recurrent non-verbal behavior of the first user and the second user comprises determining a first time window associated with the first referring expression, determining that the first user and the second user did not concurrently point at any virtual object in the VR environment within the first time window, and determining that the first user and the second user recurrently pointed at the first virtual object in the VR environment within the first time window.

6. The computer-implemented method of any of clauses 1-5, wherein analyzing the at least one concurrent or recurrent non-verbal behavior of the first user and the second user comprises determining a first time window associated with the first referring expression, determining that the first user and the second user did not concurrently or recurrently point at any virtual object in the VR environment within the first time window, and determining that the first user and the second user concurrently gazed at the first virtual object in the VR environment within the first time window.

7. The computer-implemented method of any of clauses 1-6, wherein analyzing the at least one concurrent or recurrent non-verbal behavior of the first user and the second user comprises determining a first time window associated with the first referring expression, determining that the first user and the second user did not concurrently or recurrently point at any virtual object in the VR environment within the first time window, determining that the first user and the second user did not concurrently gaze at any virtual object in the VR environment within the first time window, and determining that the first user and the second user recurrently gazed at the first virtual object in the VR environment within the first time window.

8. The computer-implemented method of any of clauses 1-7, wherein analyzing the at least one concurrent or recurrent non-verbal behavior of the first user and the second user comprises determining a set of VR samples representing the VR session, each VR sample capturing VR metadata describing a non-verbal behavior of the first user or the second user during the VR session, determining a first time window associated with a first timestamp corresponding to the first referring expression, identifying a subset of VR samples from the set of VR samples based on the first time window, and determining the first virtual object within the VR environment based on the subset of VR samples.

9. The computer-implemented method of any of clauses 1-8, wherein at least one VR sample in the set of VR samples specifies a target virtual object that is intersected by a pointing ray associated with the first user or the second user and a timestamp for when the at least one VR sample was collected during the VR session.

10. The computer-implemented method of any of clauses 1-9, wherein at least one VR sample in the set of VR samples specifies a target virtual object that is intersected by a gaze ray associated with the first user or the second user and a timestamp for when the at least one VR sample was collected during the VR session.

11. In some embodiments, one or more non-transitory computer-readable media include instructions that, when executed by one or more processors, cause the one or more processors to generate an augmented transcript of a two-user virtual reality (VR) session by performing the steps of identifying a first referring expression in a text transcript of the VR session performed by a first user and a second user in a VR environment, analyzing at least one concurrent or recurrent non-verbal behavior of the first user and the second user during the VR session to determine a first virtual object in the VR environment associated with the first referring expression, and specifying a first name of the first virtual object in the text transcript to generate the augmented transcript.

12. The one or more non-transitory computer-readable media of clause 11, wherein the at least one concurrent or recurrent non-verbal behavior includes a concurrent or recurrent pointing behavior of the first user and the second user.

13. The one or more non-transitory computer-readable media of clauses 11 or 12, wherein the at least one concurrent or recurrent non-verbal behavior includes a concurrent or recurrent gaze behavior of the first user and the second user.

14. The one or more non-transitory computer-readable media of any of clauses 11-13, wherein analyzing the at least one concurrent or recurrent non-verbal behavior of the first user and the second user comprises determining a first time window associated with the first referring expression, and determining that the first user and the second user concurrently or recurrently pointed at the first virtual object in the VR environment within the first time window.

15. The one or more non-transitory computer-readable media of any of clauses 11-14, wherein analyzing the at least one concurrent or recurrent non-verbal behavior of the first user and the second user comprises determining that the first user and the second user did not concurrently or recurrently point at any virtual object in the VR environment within a first time window associated with the first referring expression, and determining that the first user and the second user concurrently or recurrently gazed at the first virtual object in the VR environment within the first time window.

16. The one or more non-transitory computer-readable media of any of clauses 11-15, wherein analyzing the at least one concurrent or recurrent non-verbal behavior of the first user and the second user comprises selecting the first virtual object from a set of candidate virtual objects identified for a set of behavior metrics by applying a metric hierarchy to the set of candidate objects.

17. The one or more non-transitory computer-readable media of any of clauses 11-16, wherein the metric hierarchy specifies a ranking order of the set of behavior metrics comprising a concurrent pointing behavior metric, a recurrent pointing behavior metric, a concurrent gaze behavior metric, and a recurrent gaze behavior metric.

18. The one or more non-transitory computer-readable media of any of clauses 11-17, wherein analyzing the at least one concurrent or recurrent non-verbal behavior of the first user and the second user comprises determining a set of VR samples representing the VR session, each VR sample capturing VR metadata describing a non-verbal behavior of the first user or the second user during the VR session, determining a first time window associated with a first timestamp corresponding to the first referring expression, identifying a subset of VR samples from the set of VR samples based on the first time window, and determining the first virtual object within the VR environment based on the subset of VR samples.

19. The one or more non-transitory computer-readable media of any of clauses 11-18, wherein at least one VR sample in the set of VR samples specifies a target virtual object that is intersected by a pointing ray associated with the first user or the second user and a timestamp for when the at least one VR sample was collected during the VR session.

20. In some embodiments, a system comprises one or more memories storing instructions, and one or more processors coupled to the one or more memories that, when executing the instructions generate an augmented transcript of a two-user virtual reality (VR) session by performing the steps of identifying a first referring expression in a text transcript of the VR session performed by a first user and a second user in a VR environment, analyzing at least one concurrent or recurrent non-verbal behavior of the first user and the second user during the VR session to determine a first virtual object in the VR environment associated with the first referring expression, and specifying a first name of the first virtual object in the text transcript to generate the augmented transcript.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUIs, etc.) are, in various embodiments, stored in the memory/memories shown in the relevant system figure(s) and executed by the processor(s) shown in those same system figures.

Any combination of one or more non-transitory computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an augmented transcript of a two-user virtual reality (VR) session, the method comprising:
identifying a first referring expression in a text transcript of the VR session performed by a first user and a second user in a VR environment;
analyzing at least one concurrent or recurrent non-verbal behavior of the first user and the second user during the VR session to determine a first virtual object in the VR environment associated with the first referring expression; and
specifying a first name of the first virtual object in the text transcript to generate the augmented transcript.

2. The computer-implemented method of claim 1, wherein the at least one concurrent or recurrent non-verbal behavior includes a concurrent or recurrent pointing behavior of the first user and the second user.

3. The computer-implemented method of claim 1, wherein the at least one concurrent or recurrent non-verbal behavior includes a concurrent or recurrent gaze behavior of the first user and the second user.

4. The computer-implemented method of claim 1, wherein analyzing the at least one concurrent or recurrent non-verbal behavior of the first user and the second user comprises:
determining a first time window associated with the first referring expression; and
determining that the first user and the second user concurrently pointed at the first virtual object in the VR environment within the first time window.

5. The computer-implemented method of claim 1, wherein analyzing the at least one concurrent or recurrent non-verbal behavior of the first user and the second user comprises:
determining a first time window associated with the first referring expression;
determining that the first user and the second user did not concurrently point at any virtual object in the VR environment within the first time window; and
determining that the first user and the second user recurrently pointed at the first virtual object in the VR environment within the first time window.

6. The computer-implemented method of claim 1, wherein analyzing the at least one concurrent or recurrent non-verbal behavior of the first user and the second user comprises:
determining a first time window associated with the first referring expression;
determining that the first user and the second user did not concurrently or recurrently point at any virtual object in the VR environment within the first time window; and
determining that the first user and the second user concurrently gazed at the first virtual object in the VR environment within the first time window.

7. The computer-implemented method of claim 1, wherein analyzing the at least one concurrent or recurrent non-verbal behavior of the first user and the second user comprises:
determining a first time window associated with the first referring expression;
determining that the first user and the second user did not concurrently or recurrently point at any virtual object in the VR environment within the first time window;
determining that the first user and the second user did not concurrently gaze at any virtual object in the VR environment within the first time window; and
determining that the first user and the second user recurrently gazed at the first virtual object in the VR environment within the first time window.

8. The computer-implemented method of claim 1, wherein analyzing the at least one concurrent or recurrent non-verbal behavior of the first user and the second user comprises:
determining a set of VR samples representing the VR session, each VR sample capturing VR metadata describing a non-verbal behavior of the first user or the second user during the VR session;
determining a first time window associated with a first timestamp corresponding to the first referring expression;
identifying a subset of VR samples from the set of VR samples based on the first time window; and
determining the first virtual object within the VR environment based on the subset of VR samples.

9. The computer-implemented method of claim 8, wherein at least one VR sample in the set of VR samples specifies a target virtual object that is intersected by a pointing ray associated with the first user or the second user and a timestamp for when the at least one VR sample was collected during the VR session.

10. The computer-implemented method of claim 8, wherein at least one VR sample in the set of VR samples specifies a target virtual object that is intersected by a gaze ray associated with the first user or the second user and a timestamp for when the at least one VR sample was collected during the VR session.

11. One or more non-transitory computer-readable media including instructions that, when executed by one or more processors, cause the one or more processors to generate an augmented transcript of a two-user virtual reality (VR) session by performing the steps of:
identifying a first referring expression in a text transcript of the VR session performed by a first user and a second user in a VR environment;
analyzing at least one concurrent or recurrent non-verbal behavior of the first user and the second user during the VR session to determine a first virtual object in the VR environment associated with the first referring expression; and
specifying a first name of the first virtual object in the text transcript to generate the augmented transcript.

12. The one or more non-transitory computer-readable media of claim 11, wherein the at least one concurrent or recurrent non-verbal behavior includes a concurrent or recurrent pointing behavior of the first user and the second user.

13. The one or more non-transitory computer-readable media of claim 11, wherein the at least one concurrent or recurrent non-verbal behavior includes a concurrent or recurrent gaze behavior of the first user and the second user.

14. The one or more non-transitory computer-readable media of claim 11, wherein analyzing the at least one concurrent or recurrent non-verbal behavior of the first user and the second user comprises:
determining a first time window associated with the first referring expression; and
determining that the first user and the second user concurrently or recurrently pointed at the first virtual object in the VR environment within the first time window.

15. The one or more non-transitory computer-readable media of claim 11, wherein analyzing the at least one concurrent or recurrent non-verbal behavior of the first user and the second user comprises:
determining that the first user and the second user did not concurrently or recurrently point at any virtual object in the VR environment within a first time window associated with the first referring expression; and
determining that the first user and the second user concurrently or recurrently gazed at the first virtual object in the VR environment within the first time window.

16. The one or more non-transitory computer-readable media of claim 11, wherein analyzing the at least one concurrent or recurrent non-verbal behavior of the first user and the second user comprises selecting the first virtual object from a set of candidate virtual objects identified for a set of behavior metrics by applying a metric hierarchy to the set of candidate objects.

17. The one or more non-transitory computer-readable media of claim 16, wherein the metric hierarchy specifies a ranking order of the set of behavior metrics comprising a concurrent pointing behavior metric, a recurrent pointing behavior metric, a concurrent gaze behavior metric, and a recurrent gaze behavior metric.

18. The one or more non-transitory computer-readable media of claim 11, wherein analyzing the at least one concurrent or recurrent non-verbal behavior of the first user and the second user comprises:
determining a set of VR samples representing the VR session, each VR sample capturing VR metadata describing a non-verbal behavior of the first user or the second user during the VR session;
determining a first time window associated with a first timestamp corresponding to the first referring expression;
identifying a subset of VR samples from the set of VR samples based on the first time window; and
determining the first virtual object within the VR environment based on the subset of VR samples.

19. The one or more non-transitory computer-readable media of claim 18, wherein at least one VR sample in the set of VR samples specifies a target virtual object that is intersected by a pointing ray associated with the first user or the second user and a timestamp for when the at least one VR sample was collected during the VR session.

20. A system comprising:
one or more memories storing instructions; and
one or more processors coupled to the one or more memories that, when executing the instructions generate an augmented transcript of a two-user virtual reality (VR) session by performing the steps of:
identifying a first referring expression in a text transcript of the VR session performed by a first user and a second user in a VR environment;
analyzing at least one concurrent or recurrent non-verbal behavior of the first user and the second user during the VR session to determine a first virtual object in the VR environment associated with the first referring expression; and
specifying a first name of the first virtual object in the text transcript to generate the augmented transcript.
